(19) United States
(12) Patent Application Publication
(10) Pub. No.: US 2026/0162273 A1
(43) Pub. Date: Jun. 11, 2026

(54) CORNER AWARE VECTOR PATH IMITATION WITH DYNAMIC OFFSET

(71) Applicant: Adobe Inc., San Jose, CA (US)

(72) Inventors: Shikhar Tayal, Aligarh (IN); Gagan Singhal, Shakur Basti (IN)

(21) Appl. No.: 18/975,617

(22) Filed: Dec. 10, 2024

(51) Int. Cl. G06T 7/13; G06T 7/12; G06V 10/764

(52) U.S. Cl. CPC G06T 7/13; G06T 7/12; G06V 10/764

(57) ABSTRACT

The present disclosure relates to systems, non-transitory computer-readable media, and methods for detecting and imitating edges in digital images using an advanced corner correction algorithm. For example, the disclosed systems extract, from a digital image, a set of reference segments by segmenting a reference edge depicted in the digital image. In some embodiments, the disclosed systems determine a corner within the reference edge by classifying a reference edge segment among the set of reference edge segments as a corner segment. In certain embodiments, the disclosed systems also generate, for display, an imitation edge following a shape of the reference edge and including an imitation corner positioned according to the corner within the reference edge.

### BACKGROUND

Tracing and drawing edges are fundamental tasks in graphic design. Recent years have seen significant advancements in tools that aid in tracing edges in digital images, ranging from input-driven tracing using graphical pen tools to automated image tracing features that generate anchor points for vector paths. While existing systems offer limited capabilities for imitating edges with corners in digital images, these conventional systems continue to suffer from a number of disadvantages, particularly with accuracy in tracing or mirroring edges with corners and with efficiency in real-time generation of offset edges.

### SUMMARY

One or more embodiments described herein provide benefits and/or solve one or more of the foregoing or other problems in the art with systems, methods, and non-transitory computer-readable media for detecting and imitating edges in digital images using an advanced corner correction algorithm. To illustrate, the advanced corner correction algorithm of the disclosed systems involves generating an imitation edge by tracing the shape of a selected reference edge while accounting for complicated edge reconstruction that arises due to corners in the reference edge. In some embodiments, the advanced corner correction algorithm also includes techniques for generating an imitation edge through joining imitation edge segments by using methods based on corresponding corners in the reference edge. In one or more embodiments, the disclosed systems further introduce processes for generating a dynamic offset for an imitation edge based on a reference edge and user input locations. In some embodiments, the disclosed systems additionally refine the imitation edge via the advanced corner correction algorithm according to the underlying corners of the reference edge.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This Disclosure Will Describe One or More Embodiments of the Invention with Additional Specificity and Detail by Referencing the Accompanying Figures. The Following Paragraphs Briefly Describe Those Figures, in which:

FIG. 1 illustrates a schematic diagram of an example system environment for implementing a corner-aware imitation system in accordance with one or more embodiments.

FIG. 2 illustrates an overview diagram of the corner-aware imitation system generating an imitation edge with corners by tracing the shape of a selected reference edge.

FIG. 3 illustrates an example of using a corner-aware imitation system to detect corners in a reference edge segment depicted in a digital image in accordance with one or more embodiments.

FIGS. 4A-4B illustrate a corner-aware imitation system determining corner classifications for inner corners and outer corners of a reference edge in accordance with one or more embodiments.

FIG. 5 illustrates a corner-aware imitation system generating dynamic offsets in accordance with one or more embodiments.

FIGS. 6A-6B illustrate a corner correction algorithm of a corner-aware imitation system joining inner corner imitation edge segments of an imitation edge in accordance with one or more embodiments.

FIG. 7 illustrates an example of using a corner-aware imitation system to join imitation edge segments to generate an outer corner in accordance with one or more embodiments.

FIG. 8 illustrates a corner-aware imitation system generating an outer-corner fallback curve in accordance with one or more embodiments.

FIG. 9 illustrates a corner-aware imitation system generating an inner-corner fallback curve in accordance with one or more embodiments.

FIG. 10 illustrates the corner-aware imitation system providing snapping guides in accordance with one or more embodiments.

FIG. 11 illustrates a schematic diagram of a corner-aware imitation system in accordance with one or more embodiments.

FIG. 12 illustrates a flowchart of a series of acts for generating an imitation edge with corners by tracing the shape of a selected reference edge in accordance with one or more embodiments.

FIG. 13 illustrates a flowchart of a series of acts for generating an imitation edge with corners by partitioning a reference edge into triple point sets in accordance with one or more embodiments.

FIG. 14 illustrates a flowchart of a series of acts for generating an imitation edge with corners by determining corner types of an underlying reference edge in accordance with one or more embodiments.

FIG. 15 illustrates a block diagram of an example computing device for implementing one or more embodiments of the present disclosure.

### DETAILED DESCRIPTION

This disclosure describes one or more embodiments of a corner-aware imitation system that generates an imitation edge with one or more corners using advanced corner detection techniques involving a corner correction algorithm. In many use cases, graphic designers create or modify digital images or graphic designs by adding new edges, many of which mirror or resemble existing edges already depicted in an image or design. To improve on existing approaches for creating edges, in some embodiments, the corner-aware imitation system generates an imitation edge following the shape of the reference edge. As part of generating an imitation edge, the corner-aware imitation system utilizes a corner correction algorithm to refine the imitation edge to accurately mimic corners from the underlying reference edge. For instance, in one or more embodiments, the corner-aware imitation system segments the underlying reference edge according to its corners and generates corresponding imitation edge segments. Further, in some embodiments, the corner-aware imitation system performs processes to join the imitation edge segments to generate an imitation edge that has one or more corners corresponding to corners within the reference edge. In certain cases, the corner-aware imitation system positions the imitation edge according to a dynamic offset determined from one or more positions of user input within the digital image.

As just mentioned, in some embodiments, the corner-aware imitation system generates an imitation edge following the shape of a reference edge detected in a digital image. In some cases, the corner-aware imitation system generates an imitation edge following the shape of a reference edge, the imitation edge refined to have one or more corners that correspond to one or more corners within the reference edge. For example, the corner-aware imitation system follows a length of a reference edge from a first user input location to a second user input location, the imitation edge including one or more corners.

To generate corners in an imitation edge, in some embodiments, the corner-aware imitation system joins imitation edge segments using various joining methods according to a corresponding corner type in a reference edge. In some cases, joining imitation edge segments is performed using a specific process according to whether the corner in the underlying reference edge is an inner corner or an outer corner. Accordingly, in some embodiments, the corner-aware imitation system generates an inner corner within an imitation edge by joining imitation edge segments utilizing a particular method corresponding to an inner corner of the reference edge. Likewise, in some embodiments, the corner-aware imitation system generates an outer corner within an imitation edge by joining imitation edge segments utilizing a particular method corresponding to an outer corner of the reference edge.

In one or more embodiments, the corner-aware imitation system generates imitation edge segments based on reference edge segments. For instance, the corner-aware imitation system extracts reference edge segments from a reference edge, partitioning the reference edge according to detected corners within the reference edge. To facilitate such partitioning, the corner-aware imitation system performs a corner detection process to determine whether reference edge segments are smooth segments or corner segments. Further, in certain embodiments, the corner-aware imitation system determines the type of corner segment (e.g., inner or outer) based on one or more vector paths of a reference edge segment. As noted, in some cases, the corner type impacts how the corner-aware imitation system joins the segments at the corner of an imitation edge.

In some embodiments, the corner-aware imitation system positions the imitation edge according to a dynamic offset. To illustrate, in one or more embodiments, the corner-aware imitation system determines a dynamic offset by determining various offset steps (e.g. lengths) spaced according to an offset interval for an imitation edge, where the offset steps indicate the separation between the imitation edge and the reference at various positions (e.g., positions spaced apart according to the offset interval). In some cases, the corner-aware imitation system further determines a dynamic offset based on user input locations within the digital image and a length of the reference edge. For example, the corner-aware imitation system determines endpoints for an imitation edge as indicated by user-indicated locations and forms the imitation edge spanning between the endpoints, offset from the reference edge according to individual offset lines.

As suggested above, many conventional systems exhibit a number of shortcomings or disadvantages, particularly in efficiently imitating edges with corners in digital images. To elaborate, some digital illustration systems require manual positioning of each individual anchor or tangent to create an imitation edge. Not only is such positioning an acquired skill, but individually defining each discrete anchor of an edge requires an excessive number of device interactions, even for sophisticated professionals. The computational expense of processing the inputs defining each individual anchor point is compounded when generating longer and/or more complex edges. Even systems that provide rudimentary offsets only do so at a constant distance with no support of a dynamic offset. Such systems additionally do not provide real-time feedback, forcing additional device interaction to interactively and granularly increase or decrease the offset length.

Due at least in part to their inefficiencies, many prior systems are also inaccurate. Current systems, while capable of following curved reference edges, are incapable of creating accurate imitation edges when encountering corners. Upon encountering corners, systems that utilize anchor points encounter tangents approaching zero and thus create imitation edges with jarring and imprecise results. Other conventional systems create imitation edges by circumventing reference edge corners entirely, generating an imitation edge that also inaccurately matches a reference edge, only loosely following general trajectories.

In addition to problems of inefficiency and inaccuracy, conventional digital illustration systems also experience problems of operational inflexibility. For example, current systems tout capabilities of imitating edges, but the algorithms of such systems do so irrespective of corner data. Consequently, these existing systems often generate imitation edges with errors or flaws upon encountering corners, particularly sharp corners. As sharp or crisp corners commonly exist within digital images, current systems are thus rendered insufficient or ineffective. This issue is exacerbated in raster domains where raster boundaries are not as clean as vector edges and contain many small, nuanced corners inherent along their trajectories.

As suggested, one or more embodiments of the corner-aware imitation system provide several advantages over conventional digital illustration systems. For example, in one or more embodiments, the corner-aware imitation system improves computational efficiency and speed over current digital illustration systems. For instance, as mentioned, conventional digital illustration systems suffer from the computational expense of receiving and processing numerous device interactions associated with positioning individual anchor points to imitate a reference edge. In contrast, in one or more embodiments, the corner-aware imitation system generates an imitation edge, extending the imitation edge from a first user input location to a second user input location in real time (e.g., contemporaneous with, or available immediately in response to, detected input). In some embodiments, the corner-aware imitation system generates an imitation edge with few (or zero) device interactions to place and manipulate individual anchors of a vector path, instead automatically aligning the trajectory of the imitation path with the trajectory of the chosen reference. Furthermore, in some cases, the corner-aware imitation system provides real-time visual feedback on the dynamic offset of the imitation edge, eliminating the need for iterative device adjustments. Thus, the corner-aware imitation system reduces or eliminates inefficient device interactions to facilitate manipulation of anchors or tangents, providing faster, more efficient imitation of a reference edge with corners in a digital image.

Relatedly, as mentioned, the corner-aware imitation system improves over inaccuracies of prior systems, particularly at corner locations. As discussed previously, in some embodiments, the corner-aware imitation system utilizes a corner correction algorithm to accurately mimic the corners of an underlying reference edge, removing inaccuracies inherent in solely relying on anchor points. Additionally, in one or more embodiments, the corner-aware imitation system refines an imitation edge in locations determined to be corners, accurately imitating sharp or crisp underlying reference edge corners instead of treating corners as curved segments. Thus, in certain cases, the corner-aware imitation system accurately generates an imitation edge with accurate corners, providing precise imitation edge generation in real time.

Similarly, the corner-aware imitation system improves upon operational flexibility. In some embodiments, the corner-aware imitation system uses a corner correction algorithm to intelligently navigate corner imitation of both vector and raster edges, allowing for flexible imitation of lengthy edges with corners across multiple image types. For example, as opposed to an edge imitation algorithm breaking upon encountering corner data from an underlying reference edge, which is especially prevalent in raster images, the corner-aware imitation system generates an accurate imitation edge by tracing even small or nuanced corners of the reference edge, whether a vector edge or a raster edge.

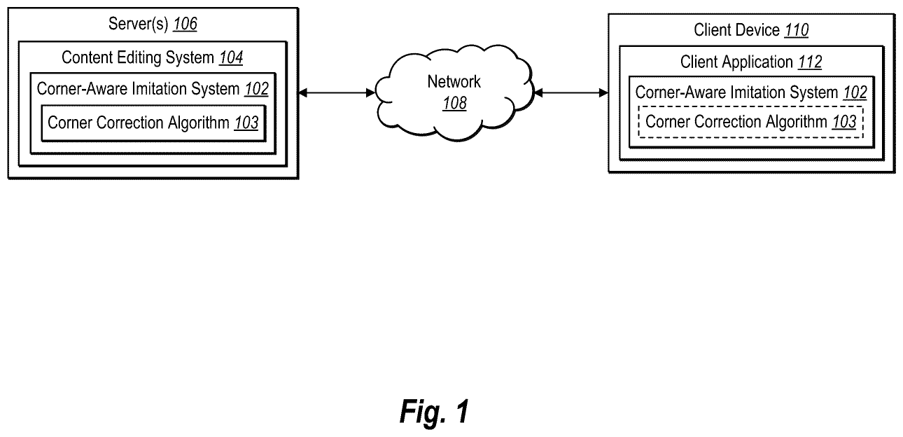

Additional detail regarding the corner-aware imitation system will now be provided with reference to the figures. For example, FIG. 1 illustrates a schematic diagram of an example system environment for implementing a corner-aware imitation system 102 in accordance with one or more embodiments. An overview of the corner-aware imitation system 102 is described in relation to FIG. 1. Thereafter, a more detailed description of the components and processes of the corner-aware imitation system 102 is provided in relation to the subsequent figures.

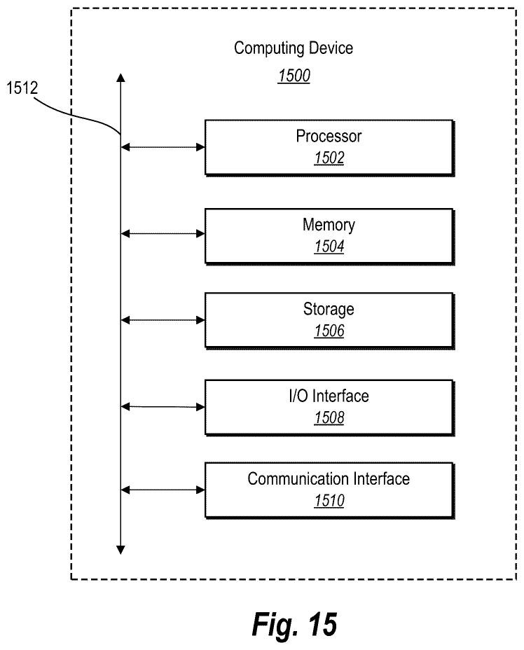

As shown, the environment includes server(s) 106, a client device 110, and a network 108. Each of the components of the environment communicate via the network 108, and the network 108 is any suitable network over which computing devices communicate. Example networks are discussed in more detail below in relation to FIG. 15.

As mentioned, the environment includes a client device 110. The client device 110 is one of a variety of computing devices, including a smartphone, a tablet, a smart television, a desktop computer, a laptop computer, a virtual reality device, an augmented reality device, or another computing device as described in relation to FIG. 15. Although FIG. 1 illustrates a single instance of the client device 110, in some embodiments, the environment includes multiple different client devices, each associated with a different user. The client device 110 communicates with the server(s) 106 and/or the content editing system 104 via network 108. For example, the client device 110 receives information from the server(s) 106 and provides information to server(s) 106 relating to raster images, vector images, and detected edges.

As shown in FIG. 1, the client device 110 includes a client application 112. In particular, the client application 112 is a web application, a native application installed on the client device 110 (e.g., a mobile application or a desktop application), or a cloud-based application where all or part of the functionality is performed by the server(s) 106. The client application 112 presents or displays information to a user, including a content editing interface for using edge detection tools and/or tracing tools to detect, modify, and/or trace edges with corners in a digital image.

As also illustrated in FIG. 1, the environment includes the server(s) 106. The server(s) 106 generates, tracks, stores, processes, receives, and transmits electronic data, such as raster images, vector images, object contours, detected edges, vector data for traced edges, corner data for reference edges, and/or edge segment data for imitation edges. For example, the server(s) 106 receives data from the client device 110 in the form of a raster image and an indication to detect depicted edges. In response, the server(s) 106 provides data to the client device 110 in the form of a vectorized image and/or detected edges, as described herein.

In some embodiments, the server(s) 106 communicates with the client device 110 to transmit and/or receive data via the network 108. In some embodiments, the server(s) 106 comprises a distributed server where the server(s) 106 includes a number of server devices distributed across the network 108 and located in different physical locations. The server(s) 106 comprise a content server, an application server, a communication server, a web-hosting server, a multidimensional server, or a machine learning server.

As further shown in FIG. 1, the server(s) 106 also includes the corner-aware imitation system 102 as part of a content editing system 104. For example, in one or more implementations, the content editing system 104 stores, generates, modifies, edits, enhances, provides, distributes, and/or shares digital content, such as digital images. For example, the content editing system 104 provides digital content for editing or other forms of digital processing. In some implementations, the content editing system 104 provides digital content to particular digital profiles associated with client devices (e.g., the client device 110).

In one or more embodiments, the server(s) 106 includes all, or a portion of, the corner-aware imitation system 102. For example, the corner-aware imitation system 102 operates on the server(s) 106 to generate imitation edges by tracing reference edges. In some embodiments, the client device 110 includes all or part of the corner-aware imitation system 102. For example, the client device 110 generates, obtains (e.g., downloads), or uses one or more aspects of the corner-aware imitation system 102, such as the corner correction algorithm 103. Indeed, in some implementations, as illustrated in FIG. 1, the corner-aware imitation system 102 is located in whole or in part of the client device 110 (e.g., as part of the client application 112). For example, the corner-aware imitation system 102 includes a web hosting application that allows the client device 110 to interact with the server(s) 106. To illustrate, in one or more implementations, the client device 110 accesses a web page supported and/or hosted by the server(s) 106.

Although FIG. 1 illustrates a particular arrangement of the environment, in some embodiments, the environment has a different arrangement of components and/or may have a different number or set of components altogether. For instance, as mentioned, the corner-aware imitation system 102 is implemented by (e.g., located entirely or in part on) the client device 110. In addition, in one or more embodiments, the client device 110 communicates directly with the corner-aware imitation system 102, bypassing the network 108.

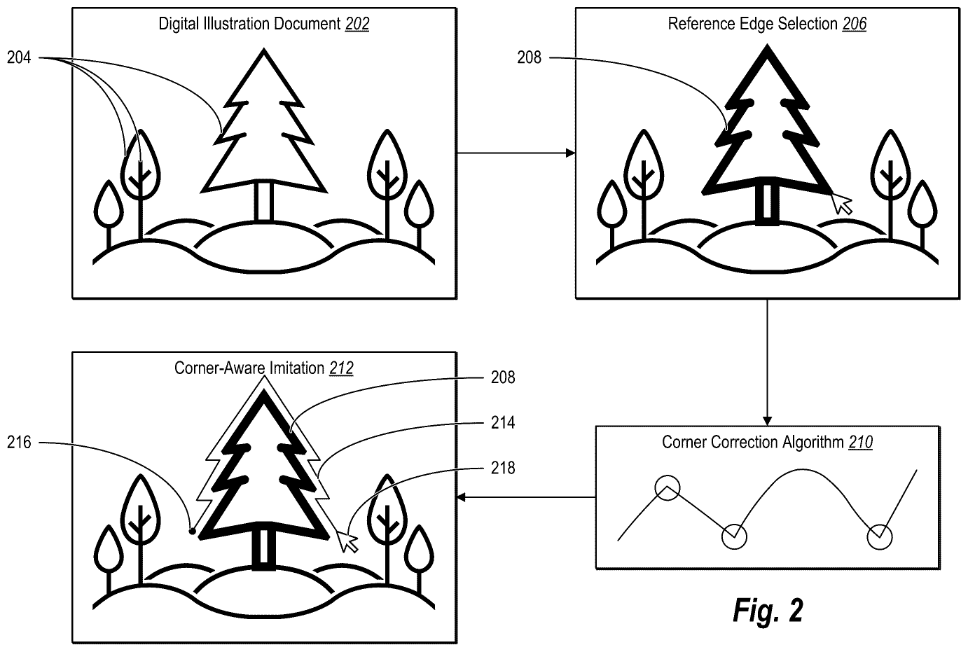

As mentioned, in one or more embodiments, the corner-aware imitation system 102 generates imitation edges by tracing reference edges in a digital image. In particular, the corner-aware imitation system 102 utilizes a corner correction algorithm 103 to generate imitation edges through tracing reference edges in a digital image. In addition, the corner-aware imitation system 102 generates imitation edges with corners corresponding to corners in a reference edge. FIG. 2 illustrates an example overview of generating an imitation edge by tracing a reference edge in a digital image and further refining corners of the imitation edge in accordance with one or more embodiments. Additional detail regarding the various acts and processes introduced in relation to FIG. 2 is provided thereafter with reference to subsequent figures.

As illustrated in FIG. 2, the corner-aware imitation system 102 identifies or receives a digital image 202. In some embodiments, the digital image 202 is a raster image depicting raster content (e.g., non-vectorized image content) arranged in a grid of individual pixels with pixel values. In other embodiments, the digital image is a vector image (e.g., with resolution-independent content) created using mathematical formulas to define the content within. In one or more embodiments, the corner-aware imitation system 102 splits or divides the digital image 202 into a plurality of candidate reference edges 204 by utilizing an edge detection algorithm. For example, a reference edge includes or refers to a vector path or raster edge in a digital image selected as a basis for imitation. In some cases, the plurality of candidate reference edges 204 are available for selection within the digital image 202.

As further illustrated in FIG. 2, the corner-aware imitation system 102 performs a reference edge selection 206. The corner-aware imitation system 102 detects a reference edge 208 selected from the plurality of candidate reference edges 204. In some embodiments, the corner-aware imitation system 102 renders candidate reference edges visible in response to detecting a particular client device input such as holding a modifier key, thereby enabling the client device to designate a single reference edge with a simple tap. For example, the corner-aware imitation system 102 facilitates this selection process through a precise hit test conducted on a temporary layer of pre-processed cubic Bezier splines of the plurality of candidate reference edges 204. In some cases, upon selection, the corner-aware imitation system 102 emphasizes the reference edge 208 (e.g., highlight, bold, dashes, fade, etc.).

As also illustrated in FIG. 2, the corner-aware imitation system 102 utilizes a corner correction algorithm 210. More particularly, the corner-aware imitation system 102 utilizes the corner correction algorithm 210 to identify one or more corners in reference edge 208 and generate an imitation edge 214, as further described below. For example, a corner includes or refers to an intersection of two line segments forming an angle, where the transition between line segments is discontinuous. In some cases, a corner in a reference edge includes or refers to a corner as described above within the selected reference edge in a digital image.

In some embodiments, the corner-aware imitation system 102, in conjunction with the corner correction algorithm 210, utilizes Bezier segments corresponding to anchor points within the reference edge 208 to classify segments of the reference edge 208 as either smooth segments or corner segments. For example, a Bezier spline includes or refers to multiple continuous piecewise Bezier segments, where each Bezier segment is specified by basis points of suitable degree. To further illustrate, a cubic Bezier spline (or path or curve) is specified by (3n+1) control points where n is the number of Bezier segments in the spline. For piecewise cubic Bezier segments with control points in R² parameterized by t∈[0.1], the Bezier curve is composed of n curve segments. Thus, there are n control point vectors, pⱼ=(p_{1,j}, p_{2,j}, p_{1,j}, p_{1,j})^{T}∈R⁸—one per segment. The corresponding Bezier segments are represented by b(t, pⱼ)=B(t)pⱼ where:

$$B ( t ) = [ \begin{matrix}{( 1 - t )}^{3} \\ 3 {( 1 - t )}^{2} t \\ 3 ( 1 - t ) {t}^{2} \\ {t}^{3}\end{matrix} ] ⊗ {Id}_{2}$$

Here, ⊗ denotes the tensor (or Kronecker) product, and Id₂ represents the 2×2 identity matrix. The parameter j represents the segment number. In some embodiments, this expression defines a Bezier curve composed of n cubic segments in R², each controlled by a set of 4 control points. The curve is parameterized by t and is constructed using the basis function B(t), which is applied to each segment's control points.

In some cases, the corner correction algorithm 210 generates reference edge segments by partitioning the reference edge 208 according to anchor points (or path segments). As further discussed below, the corner-aware imitation system 102 utilizes the corner correction algorithm 210 to classify corner segments. Classifying a reference edge segment as a corner segment is, in some cases, based on tangents associated with the Bezier segments corresponding to a reference edge segment. Indeed, the corner-aware imitation system 102 uses tangents associated with two Bezier segments comprising a reference edge segment classified as a corner segment to generate a primary bisector line. The corner-aware imitation system 102 then uses this primary bisector line to further classify the corner segment as either an inner corner or an outer corner. For example, an inner corner is related to or includes a corner (as described above) that creates a bisector angle at the corner that is less than 180 degrees. This bisector angle is measured between a first tangent line corresponding to the first line segment and the primary bisector line, determined from the first tangent line in a counterclockwise direction. Conversely, an outside corner occurs when two line segments or edges meet to create a bisector angle at the corner that is greater than 180 degrees as measured between the first tangent line and the primary bisector line, determined from the first tangent line in a counterclockwise direction.

As further shown, corner-aware imitation system 102 performs a corner-aware imitation 212 of reference edge 208 (e.g., using, or as a result of, the corner correction algorithm 210). To elaborate, the corner-aware imitation system 102 generates an imitation edge 214 by mimicking or imitating the reference edge 208 from a first input location 216 (indicating a start of the imitation edge relative to the reference edge) to a second input location 218. In particular, the corner-aware imitation system 102 generates an imitation edge using the corner correction algorithm 210 to generate a set of imitation edge segments corresponding to the set of reference edge segments previously mentioned. Specifically, in some cases, the corner correction algorithm 210 involves joining the set of imitation edge segments to ultimately generate the imitation edge 214. For example, an imitation edge includes or refers to a geometric construct in a digital image that replicates the characteristics, shape, or properties of a selected reference edge (e.g., a predefined curve or line segment). In some embodiments, an imitation edge mimics the geometric properties of a reference edge, including but not limited to curvature, angular transitions, and corner features.

Furthermore, in some embodiments, the corner correction algorithm 210 involves using the set of reference edge segments, in combination with the first input location 216 and the second input location 218, to generate a dynamic offset of the imitation edge 214. For example, an offset is a parallel displacement of an entity (e.g., shape, line, or point) from its original position by a specified distance. Furthermore, for example, a dynamic offset refers to an offset (as described previously), where the parallel displacement of an entity is a specified distance that varies based on constraints (e.g., user-defined input locations). In some cases, unlike a fixed offset, a dynamic offset ensures smooth transitions between varying offset distances (such as that determined from a first input location and a second input location) in generating a curve or path.

In particular, the corner-aware imitation system 102 uses a discrete number of points along the set of reference edge segments to generate dynamic offset lines as further discussed below. For instance, an offset line is a line segment representing a normal vector generated at specific sampled points along a reference edge. Offset lines, in some cases, are perpendicular to the tangent of the reference edge at each sample point, having lengths that vary uniformly between predefined locations (e.g., a first input location and a second input location). Subsequently, the corner-aware imitation system 102, in using the corner correction algorithm 210, connects a portion of the dynamic offset lines using a curve fitting algorithm to generate an imitation edge segment. For example, the curve fitting algorithm fits a cubic Bezier spline through a set of candidate points (e.g., candidate anchor points or segments) created by the dynamic offset lines. To further illustrate, an imitation edge segment is a set of points at a distance from the reference edge connected by a curve fitting algorithm and based on an underlying reference edge segment (e.g., a smooth segment or a corner segment).

In fitting a cubic Bezier spline through the candidate points, in some cases, the corner-aware imitation system 102 creates unintentional closed loops at locations corresponding to underlying corners in the reference edge 208. Thus, the corner-aware imitation system 102 utilizes the corner correction algorithm 210 to refine the generated imitation edge 214. For example, the corner correction algorithm 210 involves joining the set of imitation edge segments discussed above in various methods according to the corner type classification of corresponding corners in the reference edge 208. For instance, when the corner-aware imitation system 102 joins two segments from the set of imitation edge segments according to an underlying inner corner of the reference edge 208, the corner-aware imitation system 102 generates an imitation corner by utilizing an inner corner joining method. Conversely, when joining according to an underlying outer corner, the corner-aware imitation system 102 generates an imitation corner by utilizing an outer corner joining method, as further discussed below. For example, an imitation corner is a corner (as described above—e.g., an intersection of two line segments forming an angle) within an imitation edge that mimics or imitates a corresponding corner in a reference edge.

Furthermore, in some cases, the corner correction algorithm 210 uses fallback sub-algorithms in generating the imitation edge 214 in certain conditions. For example, if joining two imitation edge segments to form an outer corner using an outer corner joining method would create an imitation edge that exceeds a tilt threshold, the corner-aware imitation system 102 (using the corner correction algorithm 210) uses an outer-corner fallback algorithm to join the relevant segments. In various embodiments, the corner-aware imitation system 102 (using the corner correction algorithm 210) performs outer-corner fallback by determining an intersection point of the tangents of the two imitation edge segments to be joined to create an outer corner of an imitation edge. The corner-aware imitation system 102 further determines a tilt from the intersection point. If the tilt threshold is above a predetermined threshold, then the corner-aware imitation system 102 uses an outer-corner fallback approach.

In other cases, the corner correction algorithm 210 uses an inner-corner fallback algorithm if, when joining two imitation edge segments to create an inner corner in the imitation edge, the generated inner corner would exceed a predetermined tilt threshold. For example, when a tilt threshold is exceeded, the corner-aware imitation system 102 re-classifies the underlying corner segment of the reference edge as a smooth segment. As such, the corner-aware imitation system 102 generates the imitation edge 214 as if the original inner corner segment was classified as a smooth segment.

As also illustrated in FIG. 2, in some embodiments, the corner-aware imitation system 102 facilitates generating an imitation edge 214 by providing an equal offset snapping element in the digital image. For example, a snapping element is a feature in a content editing system that aids in the alignment, attachment, or positioning of an object or entity (e.g., shapes, lines, or images) relative to another entity (or reference plane or edge) with precision and ease. In some cases, by using the equal offset snapping element, the corner-aware imitation system 102 wholly or in part automatically snaps (e.g., moves) the imitation edge such that the final offset (distance from second input location 218 to reference edge 208) is equal to that of the first offset (distance from the first input location 216 to the reference edge 208). In one or more embodiments, when the corner-aware imitation system 102 detects that the second input location 218 is within a predetermined threshold distance, the corner-aware imitation system 102 snaps or moves the imitation edge 214 accordingly.

Additionally, when not within a predetermined tolerance of the reference edge, the corner-aware imitation system 102, in some embodiments, provides an unequal offset feedback guide. In various cases, the unequal offset feedback guide displays an element indicating the final offset (distance from the second input location 218 to the reference edge 208). As discussed in greater detail below, the unequal offset feedback guide displays real-time feedback (e.g., a distance number that updates with movement of the second input location 218) regarding the distance of the imitation edge 214 from the reference edge 208.

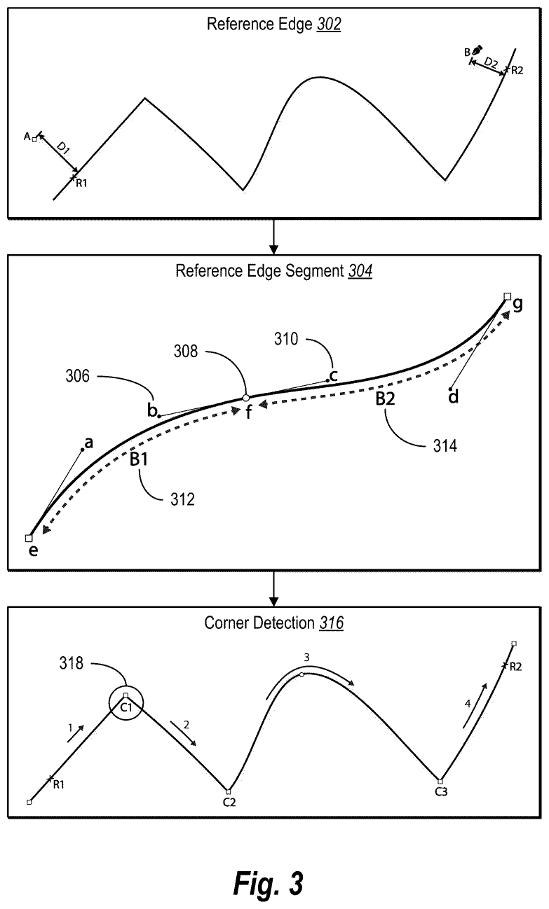

As mentioned above, in certain described embodiments, the corner-aware imitation system 102 uses a corner correction algorithm 210 to detect corners within a reference edge 208. In particular, the corner correction algorithm 210 partitions a selected reference edge into segments and classifies the segments as either smooth segments or corner segments. FIG. 3 illustrates an example of detecting corners in a reference edge segment depicted in a digital image in accordance with one or more embodiments.

As illustrated in FIG. 3, the corner-aware imitation system 102 identifies or receives a reference edge 302. For instance, the corner-aware imitation system 102 receives the reference edge 302 as a selection from a client device (e.g., the client device 110). As mentioned, in some embodiments, the corner-aware imitation system represents a reference edge 302 in one or more ways. In some cases, the corner-aware imitation system 102 represents a reference edge 302 with cubic Bezier splines or paths as multiple continuous piece-wise cubic Bezier segments (e.g., a first cubic Bezier segment 312 and a second cubic Bezier segment 314). Alternatively, or in addition, the corner-aware imitation system 102 represents a reference edge by connecting a series of points (e.g., anchor points or path segments). In such cases, the corner-aware imitation system 102 represents a reference edge 102 as E, composed of n path segments, expressed as {S₁, S₂, . . . , Sₙ} where each path segment Sᵢ is defined by the set of three points: S_{i,p} (e.g., segment location 308), S_{i,in} (e.g., in-tangent location 306), and S_{i,out} (e.g., out-tangent location 310).

As shown, the corner-aware imitation system 102 partitions the reference edge 302 into a plurality of reference edge segments comprising at least one reference edge segment 304. For example, a reference edge segment 304 (path segment) is a discrete portion of a path or edge defined by a set of points that determine its geometry, the reference edge segment bordered or enclosed by anchor points (terminal or non-terminal anchor points). To further illustrate, a segment location (anchor point) represents the path segment's main position on the path, an in-tangent location determines the direction and magnitude of the curve as it approaches the anchor point from the preceding segment, and an out-tangent location determines the direction and magnitude of the curve as it leaves the anchor point toward the next segment. Additionally, a reference edge segment, in some embodiments, is bordered by either non-terminal path segments or terminal path segments (as illustrated in FIG. 3, reference edge segment 304 is enclosed by terminal path segments). For example, a terminal path segment (anchor point) is a path segment at an end of an edge that has a segment location and either an in-tangent location or an out-tangent location (not both an in-tangent and out-tangent).

As further illustrated, the corner-aware imitation system 102 performs corner detection 316 among the plurality of reference edge segments (e.g., using the corner correction algorithm 210). For example, the corner-aware imitation system 102 classifies a reference edge segment 304 as a corner segment 318 based on predetermined criteria. The corner-aware imitation system 102 classifies a reference edge segment 304, in some cases, as a corner segment 318 when the in-tangent location 306 and the out-tangent location 310 of the reference edge segment are equal (or within a threshold difference).

Additionally, in some cases, the corner correction algorithm classifies a reference edge segment 304 as a corner segment 318 when the out-tangent location 310 equals the segment location 308 (or is within a threshold difference) or when the in-tangent location 306 equals the out-tangent location 310 (or is within a threshold difference). Alternatively, in various cases, the corner correction algorithm classifies the reference edge segment 304 as a corner segment 318 when an angle between a vector from the in-tangent location 306 to the segment location 308 and a vector from the segment location 308 to the out-tangent location 310 is within a predetermined tolerance. For example, the corner-aware imitation system 102 sets the predetermined tolerance to 10 (e.g., 10 degrees or 10 radians). In some embodiments, if the reference edge segment 304 is not classified as a corner segment 318, the corner-aware imitation system 102 will classify the reference edge segment 304 as a smooth segment (e.g., a non-corner segment).

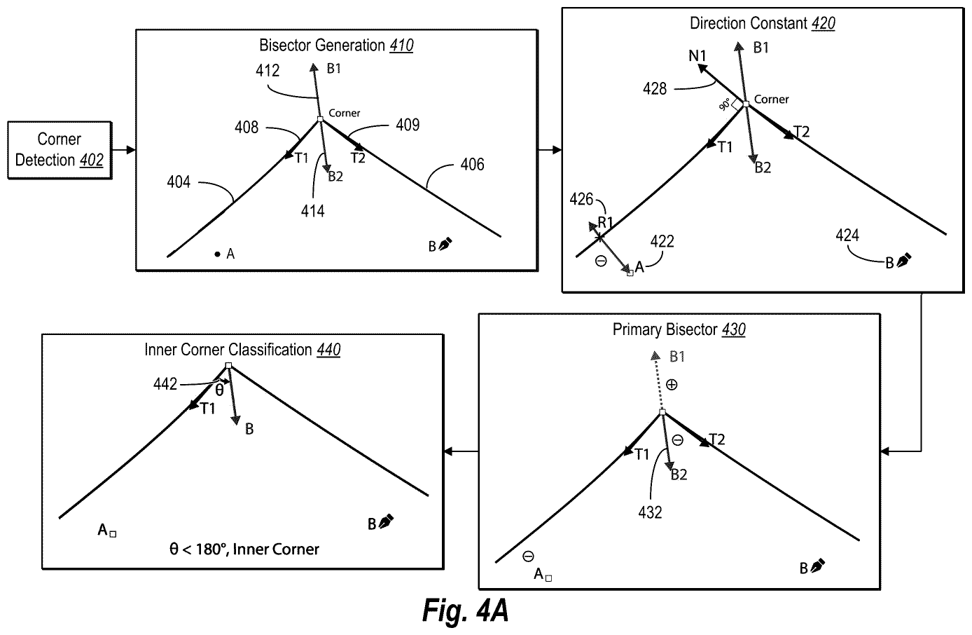

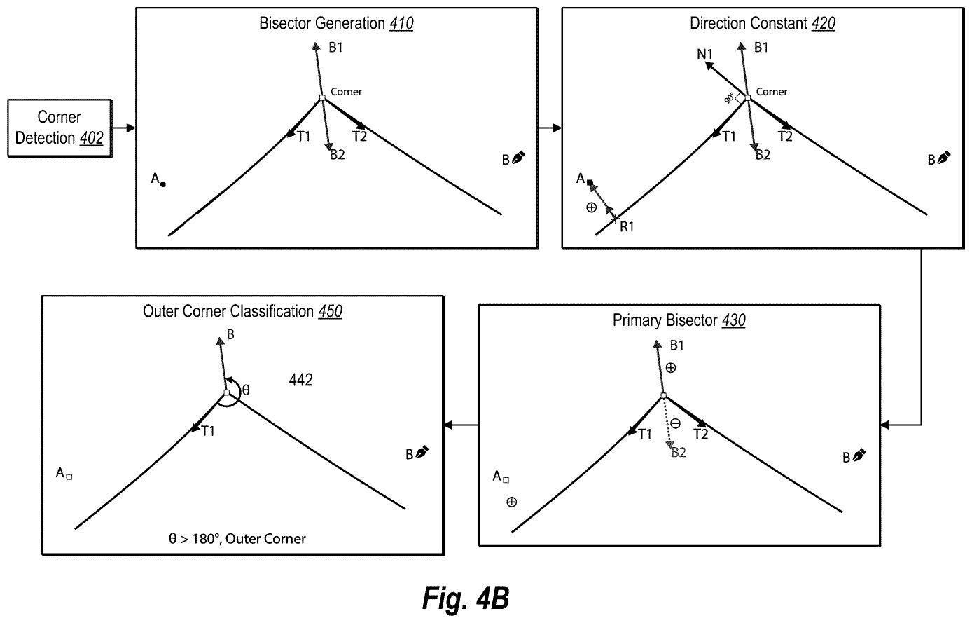

As noted above, in certain described embodiments, the corner-aware imitation system 102 utilizes a corner correction algorithm to generate an imitation edge with corners. In particular, the corner-aware imitation system 102 uses a corner correction algorithm to detect and classify corners in an underlying reference edge and generate an imitation edge at a dynamic offset according to user input locations. FIGS. 4A-4B illustrate determining corner classifications for inner corners and outer corners of a reference edge in accordance with one or more embodiments.

As illustrated in FIG. 4A, the corner-aware imitation system, based on prior corner detection 402 (for each corner detected in the reference edge), generates bisector lines 410. Specifically, tangents are generated from the two Bezier curves that joined to make up the corner segment. As shown, the corner-aware imitation system 102, in combination with the corner correction algorithm, generates tangent lines at specific points on the cubic Bezier curve associated with a non-terminal path segment that the corner-aware imitation system 102 has identified as a corner segment.

To generate a tangent for a Bezier curve, the Bezier curve is expressed as a vector function B′(t)=(B₁(t), B₂(t), B₃(t), B₄(t)), where t varies from 0 to 1. Each Bᵢ(t) represents a cubic Bezier component. The corner-aware imitation system 102 then determines the derivative of the Bezier curve with respect to t to obtain the tangent vector

$${B}^{′} ( t ) = ( \frac{{dB}_{1}}{dt} , \frac{{dB}_{2}}{dt} , \frac{{dB}_{3}}{dt} , \frac{{dB}_{4}}{dt} ) .$$

To find the tangent vector at the specific point of interest, the corner-aware imitation system 102 substitutes to into the tangent vector B′(t₀) to find the tangent vector at the specific point of interest. The tangent line at t₀ is defined by the line passing through the points B(t₀) and B′(t₀). In some cases, the tangent line is represented by the equation L(t), where B(t₀)+(t−t₀). B′(t₀)=0.

In one or more embodiments, the corner-aware imitation system, with corner correction algorithm, generates a first tangent line 408 associated with an end of a first cubic Bezier 404 associated with a corner segment. Similarly, the corner-aware imitation system 102 generates a second tangent line 409 associated with an end of a second cubic Bezier 406 associated with a corner segment. As discussed previously, this second tangent is also associated with the end of the second cubic Bezier that is joined with the first Bezier to create the underlying corner segment. From the two tangents corresponding to the two Bezier segments, the corner-aware imitation system 102 generates two bisector lines (e.g., first bisector 412, second bisector 414), which bisect the tangent lines. In some cases, there are two bisector lines generated for each corner segment. For example, a bisector line refers to a line segment that divides an angle into two equal angles where the bisector line originates from the vertex of an angle.

As further shown in FIG. 4A, the corner-aware imitation system 102 generates a direction constant 420. In particular, the corner-aware imitation system 102 generates normal unit vector 428. Additionally, the corner-aware imitation system 102 generates a direction constant 420 using normal unit vector 428 at a first reference location 426 (“R1”) on the reference edge relative to a first input location 422. The first reference location 426 is the position on the reference edge closest to the first input location 422 (“A”). If a vector from R1 to A is in the same direction as the normal unit vector 428, there is a positive direction constant. Alternatively, if the vector from R1 to A is not in the same direction as the normal vector, the direction constant is negative. If the first input location 422 lies on the reference edge, the vector joining R1 and A will be zero. In this case, the direction constant will be generated using the second input location 424. If the first input location 422 and the second input location 424 are both on the reference edge, this step of generating a direction constant 420 is not needed.

As further illustrated, the corner-aware imitation system 102 generates the primary bisector line 430 based on the direction constant 420. For example, a primary bisector line is a bisector line (further defined above) that is in the same direction as the direction constant with the normal vector on the corner at the tangent is selected as the primary vector. In some cases, the length of primary bisector line 432 is represented by:

$$L = D 1 + stepOffset * PathLength ( R 1 , S )$$

where

$$stepOffset = \frac{D 2 - D 1}{PathLength ( R 1 , R 2 )}$$

and S is the corner segment. In these cases, D2 is the Euclidian distance from the second input location to the reference edge (at location R2) and D1 is the Euclidean distance from the first input location to the reference edge (at location R1).

As shown, the corner-aware imitation system 102 uses the primary bisector line to determine the corner type. The corner-aware imitation system 102, in some embodiments, determines the bisector angle between the first tangent line 408 and the primary bisector line 432 determined from the first tangent line 408 in a counterclockwise direction. Alternatively, the corner-aware imitation system 102 determines the bisector angle between the second tangent line 409 and the primary bisector line 432 starting from the second tangent line 409 in a clockwise direction. If the bisector angle 442 is less than 180 degrees, the corner-aware imitation system 102 classifies the corner segment as an inner corner 440.

In FIG. 4B, the corner-aware imitation system 102 classifies a corner segment as an outer corner. Indeed, the corner-aware imitation system 102 determines that the bisector angle 442 is greater than 180 degrees and thus corner correction algorithm 210 classifies the detected corner segment as an outer corner.

In one or more embodiments, following the identification and classification of corner segments, the corner-aware imitation system 102 applies a filtering process to ensure the imitation edge avoid abrupt, sharp turns and aligns with the anticipated curvature expected by the user. The filtering process is contingent on the distance of the first offset and the final offset. In some embodiments, when the first offset and final offset are short distances, indicating proximity to the reference edge, only a minimal number of corners will be omitted. Conversely, when the first offset and final offset are relatively large, which is indicative of a user working at a distance from the reference edge, only the most significant corners are retained, and less substantial corners are excluded.

In some cases, to determine whether a corner on the reference edge should be skipped, the corner-aware imitation system utilizes the primary bisector line, as determined above. When the length of the primary bisector line of the current corner is greater than the distance between the current corner and the previous corner, the corner-aware imitation system 102 skips the corner in generating the imitation edge. The following equation represents this determination: L>D(S, Sₚᵣₑᵥ), where L is the length of the primary bisector line, S is the current corner, and Sₚᵣₑᵥ is the previous corner.

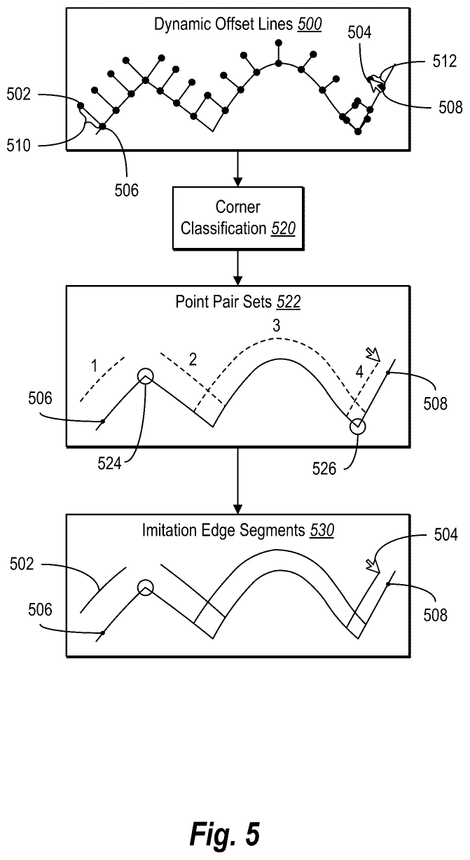

As noted above, in certain described embodiments, the corner-aware imitation system 102 utilizes a primary bisector line to classify corner segments as either inner corners or outer corners. Additionally, the corner-aware imitation system uses the corner classification to generate dynamic offsets. FIG. 5 illustrates a corner-aware imitation system generating dynamic offsets in accordance with one or more embodiments.

As illustrated in FIG. 5, the corner-aware imitation system 102 generates imitation edge segments 530 according to dynamic offset lines 500. Specifically, corner-aware imitation system 102, using the corner correction algorithm, utilizes a discrete number of points along the reference edge to determine dynamic offset lines 500 such that the length of the dynamic offset lines 500 varies uniformly from a first input location 502 to a second input location 504. For example, the dynamic offset lines 500 are generated based on a length of the reference edge (e.g., a path length) from a first reference point 506 to a second reference point 508.

In some embodiments, the corner-aware imitation system 102 determines a path length from a first reference point 506 that corresponds to a first input location 502 (e.g., a location selected via a client device as a starting point for an imitation edge) and a second reference point 508 that corresponds to a second input location 504 (e.g., a location selected via a client device as an ending point for an imitation edge). For example, the distance between the first reference point 506 and the corresponding first input location 502 is a first offset 510 and the distance between the second reference point 508 and the second input location 504 is a final offset 512. Furthermore, in some distances, the first offset 510 and the final offset are the Euclidian distances from the relevant user input point to the reference edge.

In various embodiments, the corner-aware imitation system 102 uses the corner correction algorithm to generate dynamic offset lines 500 by determining a step offset and a step interval. For example, the step interval is the path length divided by a fidelity parameter n. In some cases, a fidelity parameter is a variable predefined by the corner-aware imitation system 102 (or modifiable by a user) that indicates the level of similarity of the imitation edge to the reference edge. Additionally, the higher the value of the fidelity parameter, the closer the corner-aware imitation system 102 will imitate the reference edge trajectory in generating an imitation edge, as a greater value of the fidelity parameter corresponds to increasing a quantity of offset lines relative to the fidelity parameter (a greater number of points sampled along the reference edge). To illustrate, the corner-aware imitation system 102 will determine a number of points to sample along the reference edge corresponding to the value of the fidelity parameter. For a higher value fidelity parameter, the corner-aware imitation system 102 will create a smaller step interval and correspondingly will create a larger number of points to sample. This will, in turn, create higher number of dynamic offset lines, creating an imitation edge that more closely follows the trajectory of the reference edge.

In some embodiments, the corner-aware imitation system 102 generates dynamic offset lines 500. In some cases, this dynamic offset lines vary in length as the corner correction algorithm traces the trajectory of the reference edge. In various embodiments, the corner-aware imitation system 102 calculates an offset line for each of the sampled reference edge points based on the length of the first offset 510 and the length of the final offset 512. Specifically, the length of the dynamic offset lines increases by an incremental offset amount. For instance, the corner-aware imitation system 102 determines an incremental offset (step offset) by dividing the difference between the length of the final offset 512 and the first offset 510 by the path length. In some embodiments, this is represented by the equation

$$stepOffset = \frac{D 2 - D 1}{PathLength ( R 1 , R 2 )} .$$

In one or more embodiments, the corner-aware imitation system 102 generates a number of point pairs based on the dynamic offset lines. For example, the corner-aware imitation system 102 generates a list such as {(S₁, N₁), (S₂, N₂), (S₃, N₃) . . . (Sₙ, Nₙ)} where (Sᵢ, Nᵢ) is the pair of points. In some instances, the first point of the pair Sᵢ is a point on the reference edge which is the source point used to determine a corresponding candidate imitation edge point. Second point of the pair Nᵢ is the corresponding candidate point on the imitation edge. The span between Sᵢ and Nᵢ are thus the dynamic offset lines 500 at corresponding Sᵢ, whose lengths vary uniformly from the first input location 502 to the second input location 504. In some embodiments, the corner-aware imitation system 102 performs this point pair generation by executing an algorithm represented by the following pseudo code:

Offset Lines Algorithm

```
Data:
E, A, B, R1, R2, n ← input parameters
Result: Returns list of paired points, each pair corresponds to a point
on E and a point on the resultant curve
begin
L = PathLength(R1, R2) ← length of E between R1 and R2
D1 = D(A, R1) ← euclidean distance between A and R1
D2 = D(B, R2) ← euclidean distance between B and R2
stepOffset = (D2 − D1) / L
stepInterval = L / n
curvePairArray ← empty list of paired points
  foreach i ∈ [1, n] do
    moveDistance ← (stepInterval * i)
    offsetDistance ← D1 + (stepOffset * moveDistance)
    P1 ← point on E at a distance of R1 + moveDistance
    NV ← unit normal vector at point P1
    P2 = P1 + (offsetDistance * NV)
    curvePairArray ← Append (P1, P2)
return curvePairArray
```

As previously discussed, in certain described embodiments, the corner-aware imitation system 102 determines one or more corners in the reference edge and further classifies the corners as either inner corners or outer corners. Using previously determined corner classifications 520, the corner-aware imitation system 102 generates one or more point pair sets 522. Specifically, corner-aware imitation system 102 utilizes dynamic offset lines 500 in combination with the corner classifications 520 to generate one or more point pair sets 522.

For example, the corner-aware imitation system 102 performs a corner-to-corner edge traversal, grouping point pairs into sets that represent point pairs located in-between identified corners. For example, the corner-aware imitation system 102 groups dynamic offset lines from the first reference point 506 to the first corner into a first set. In various cases, the grouping of the first set of point pairs is based on an underlying first curve segment. In some embodiments, the corner-aware imitation system 102 generates a first point pair set from the first corner to the second corner, a second point pair set from the second corner to the third corner, and so on. In some cases, the corner-aware imitation system generates point pair sets until the corner correction algorithm generates a final set—that of the last determined corner 526 to the second reference point 508. In some embodiments, the corner-aware imitation system 102 performs a corner-to-corner traversal process by executing an algorithm represented by the following pseudo code:

Corner to Corner Edge Traversal Algorithm

```
Data:
E, A, B, R1, R2 ← input parameters described above
listOfCorners ← List Of Non-Terminal True Corners in Reference Edge E
Result: Returns list of sequences of paired points, each pair corresponding to a point on
the reference curve E and a point on the resultant imitation edge
begin
previousA = A
previousB = B
n = size of listOfCorners
L = PathLength(R1, R2) ← length of the reference edge between R1 and R2
D1 = D(A, R1) ← Euclidean distance between A and R1
D2 = D(B, R2) ← Euclidean distance between B and R2
stepOffSet = (D2 − D1)/L
stepInterval = L / n
listOfIndividualCurvePointsPair ← empty list of vector of paired points
  foreach i ∈ [0, n − 1] do
  approxEndPointOnPrevBezier ← point of previous Bezier curve very close to end
of previous Bezier or t ≈ 1; approxStartPointOnNextBezier ← point on next Bezier curve
very close to start of next Bezier or t ≈ 0;
  offsetDistance1 ← D1 + (stepOffset * PathLength(R1,
approxEndPointOnPrevBezier))
  offsetDistance2 ← D1 + (stepOffset * PathLength(R1,
approxStartPointOnNextBezier)
  NV1 ← unit normal vector at point approxEndPointOnPrevBezier
  NV2 ← unit normal vector at point approxStartPointOnNextBezier
  newA ← previousA
  newB ← approxEndPointOnPrevBezier + (offsetDistance1 * NV1)
  newR1 ← previousR1
  newR2 ← approxEndPointOnPrevBezier
  previousA ← approxStartPointOnNextBezier + (offsetDistance2 * NV2)
  previousR1 ← approxStartPointOnNextBezier
  curvePairArray ← OffsetLinesComputation(newA, newB, newR1, newR2, E)
  listOfIndividualCurvePair ← Append (curvePairArray)
return listOfIndividualCurvePair
```

As further illustrated in FIG. 5, in one or more embodiments, the corner-aware imitation system 102 generates imitation edge segments 530. In some cases, the corner-aware imitation system 102 connects the candidate points of one or more point pair sets 522 by a curve fitting process. In some embodiments, corner-aware imitation system 102 uses a process such that the candidate points of the point pair set are used to fit a cubic Bezier spline. For example, the corner-aware imitation system 102 utilizes an algorithm such as that utilized in ADOBE ILLUSTRATOR CORNUCOPIA to produce a vector path using the candidate point of a point pair set. For instance, imitation edge segments 530 are generated by corner-aware imitation system 102 using a curve fitting process through the candidate points of one or more point pair sets 522.

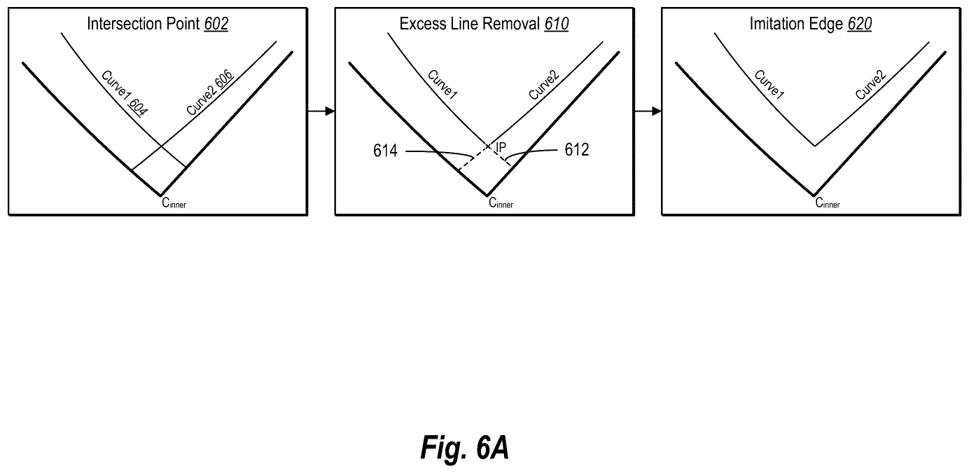

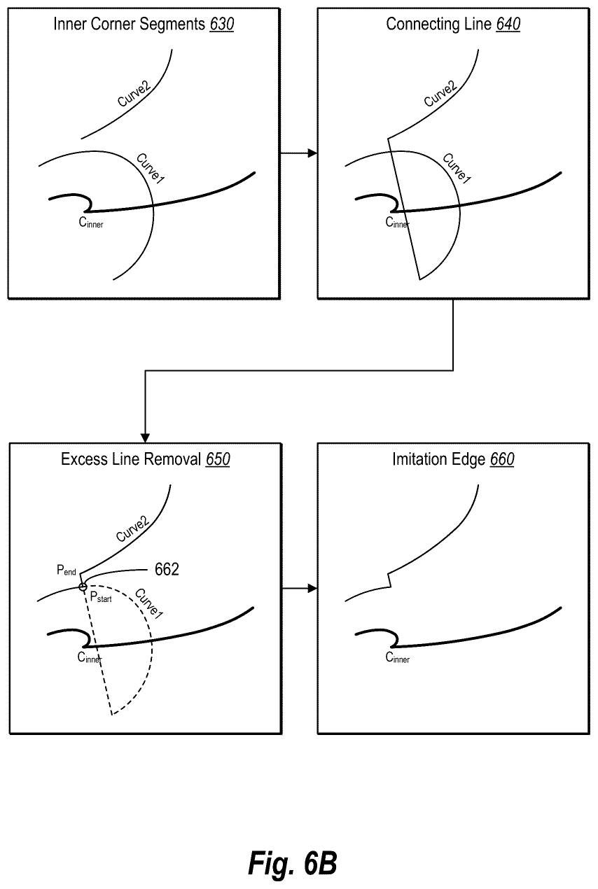

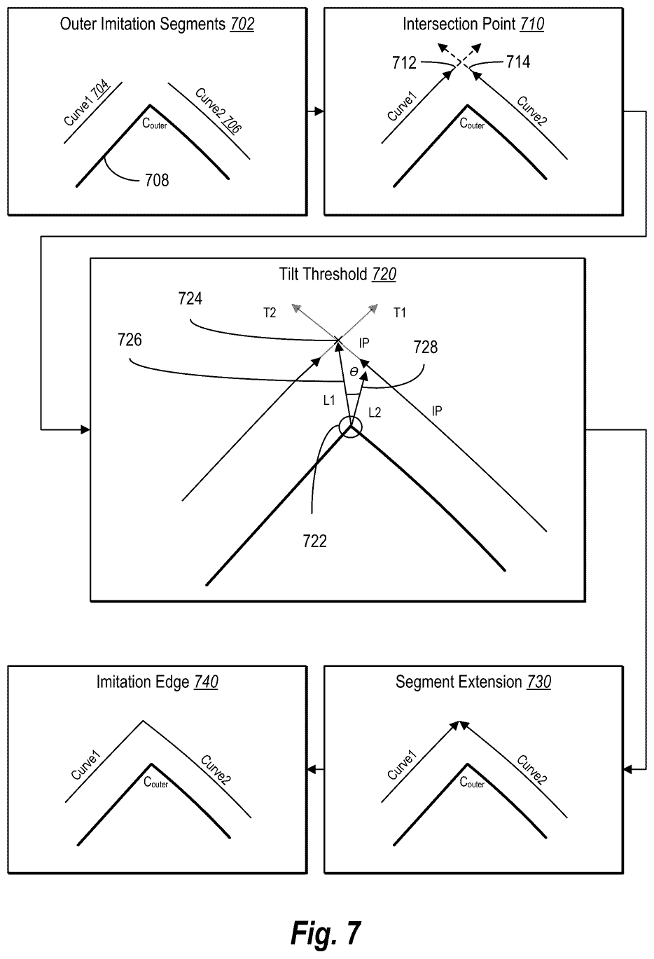

As mentioned above, in certain described embodiments, the corner-aware imitation system 102 utilizes corner classifications and dynamic offset lines to generate imitation edge segments 530. In addition, the corner-aware imitation system 102 uses various processes to join the imitation edge segments to generate an imitation edge segment. FIGS. 6A-6B illustrate joining inner corner imitation edge segments of an imitation edge in accordance with one or more embodiments. Thereafter, FIG. 7 illustrates joining imitation edge segments to generate an outer corner in accordance with one or more embodiments.

As illustrated in FIG. 6A, in some embodiments, the corner-aware imitation system 102 generates an inner corner of an imitation edge by joining intersecting imitation edge segments. For example, the corner-aware imitation system 102 employs the corner correction algorithm to detect an intersection point 602 of two imitation edge segments that correspond to an inner corner of the underlying reference edge. Specifically, the intersection point 602 is the point at which a first inner imitation edge segment 604 and a second inner imitation edge segment 606 intersect.

As further shown in, in various embodiments, the corner-aware imitation system 102 generates an imitation edge 620 by identifying and removing excess portions of inner imitation edge segments 610. Specifically, the first inner imitation edge segment 604 has a second end that is intersecting with the first end of a second inner imitation edge segment 606. The corner-aware imitation system 102 identifies and removes an excess portion 612 of the second end of the first inner corner imitation edge segment that extends past the point where the two inner corner imitation edge segments intersect. Similarly, the corner-aware imitation system 102 identifies and removes an excess portion 614 of the first end of the second inner corner imitation edge segment that extends past a point where the second inner corner imitation edge segment intersects the first inner corner imitation edge segment.

As illustrated in FIG. 6B, in some embodiments, the corner-aware imitation system 102 generates an imitation edge with an inner corner where two imitation edge segments do not intersect. As shown, the corner-aware imitation system 102 identifies two inner imitation segments 630 that do not intersect with each other. Upon detection, in some cases, the corner-aware imitation system 102 generates a connecting line segment 640 from the second end of the first inner imitation segment to the first end (e.g., beginning) of the second inner imitation segment.

In some embodiments, if the connecting line segment intersects either the first inner imitation segment or the second imitation segment at points other than the second end of the first inner imitation segment and the first end of the second inner imitation segment, additional steps are taken. In various embodiments, as shown, the corner-aware imitation system performs excess line removal 650. In these cases of excess intersections, the corner-aware imitation system identifies a first intersection point closest to a first end of the first inner imitation segment. In some cases, excess segments of the first inner imitation segment are removed after the first intersection point 662. Similarly, the corner-aware imitation system 102 identifies a second intersection point in some embodiments, where the second intersection point is the intersection point closest to the second end of the second inner imitation segment. The corner-aware imitation system 102 removes excess portions of the second inner imitation segment before the second intersection point to generate an imitation edge 660.

As mentioned above, FIG. 7 illustrates an example of joining imitation edge segments to generate an outer corner in accordance with one or more embodiments. In some embodiments, the corner-aware imitation system joins outer imitation segments 702, comprising a first segment 704 and a second segment 706. The corner-aware imitation system 102 joins the outer imitation segments 702 using a method corresponding to the reference edge 708 underlying corner classification (e.g., an outer corner). To join two outer imitation segments that do not intersect, the corner-aware imitation system 102 generates a first tangent line 712 corresponding to a tangent line at the approximate end of the first segment 704. For example, the tangent line where t=1 at the last cubic Bezier of the first segment 704. Similarly, in some cases, the corner-aware imitation system 102 generates a second tangent line 714 based on the tangent line corresponding to the approximate start of the second segment 706. For example, the corner correction algorithm 210 determines the second tangent line 714 at t=0 at the first cubic Bezier of the second segment 706. In some embodiments, the corner-aware imitation system 102 determines an intersection point 710 of the first tangent line 712 and the second tangent line 714. If the tangent lines do not intersect, the corner correction algorithm 210 extends the tangent lines until the first tangent line and the second tangent line intersect.

As illustrated, in one or more embodiments, the corner-aware imitation system 102 determines a tilt threshold 720. The corner-aware imitation system 102 generates a tilt line 726 that spans from the underlying corner of the reference edge 722 to the intersection point 724. The corner-aware imitation system 102, in some cases, further determines a title angle between the tilt line 726 and a primary bisector line 728, which is determined using processes discussed above. Furthermore, the corner-aware imitation system 102, using a predetermined MaxThreshold, compares the length of the primary bisector to the tilt line. For example, the corner correction algorithm 210 uses the following algorithms where the MaxThreshold value is set to 5 (a multiplier of 5):

$$TiltLineLength <= MaxThreshold * BisectorLength AND TiltAngle < 45 °$$

If both above conditions are met, the corner-aware imitation system 102 uses the intersection point to join the first segment 704 and the second segment 706. If the above conditions are not met, the corner correction algorithm performs outer-corner fallback, as further discussed below. Additionally, in some cases, the MaxThreshold is variable and is modified by the corner-aware imitation system 102 or, alternatively, by a user.

As further shown in FIG. 7, the corner-aware imitation system 102, in various cases, determines that conditions are met and extends the first segment and the second segment 730. The corner-aware imitation system 102, utilizing the corner correction algorithm, extends the first segment 704 along the first tangent line 712 to the intersection point. Similarly, the corner-aware imitation system 102 extends the second segment 706 along the second tangent line 714 to the intersection point 724 to generate an imitation edge 740.

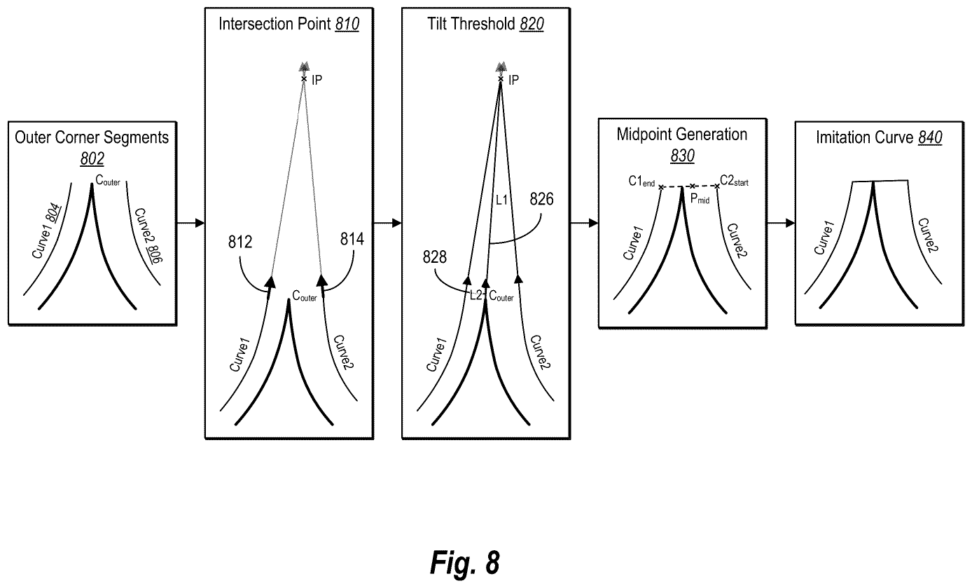

As noted above, in certain embodiments, the corner-aware imitation system 102 joins outer imitation segments to generate an outer corner in an imitation curve. In addition, the corner-aware imitation system 102 determines specific conditions in which joining outer imitation segments at an intersection point is jarring and instead performs outer-corner fallback. FIG. 8 illustrates generating an outer-corner fallback curve in accordance with one or more embodiments.

As illustrated in FIG. 8, the corner-aware imitation system determines that two outer corner segments 802 are to be joined according to an outer corner process to generate an imitation edge. Following the process described in FIG. 7, the corner-aware imitation system 102 determines an intersection point 810, formed by the convergence of a first tangent 812 and a second tangent 814 corresponding to the first segment 804 and second segment 806 respectively.

Additionally, in illustrated the corner-aware imitation system 102 evaluates a tilt threshold 820. The corner-aware imitation system 102, as discussed above, determines a tilt line 826 and a primary bisector line 828. However, in some cases, the length of the tilt line 826 is greater than a predetermined MaxThreshold multiplied by the length of the primary bisector line 828. In such cases, the corner-aware imitation system does not join the first segment 804 (a first imitation edge segment and the second segment 806 (a second imitation edge segment) at an intersection point. Rather, as illustrated, the corner-aware imitation system generates a midpoint 830 between first segment 804 and the second segment 806. The corner-aware imitation system 102 determines a middle distance between the end of the first segment 804 and the beginning of the second segment 806. Utilizing the midpoint, the corner-aware imitation system 102 generates an imitation curve 840 by joining the first segment 804 and the second segment 806 with a connecting line segment passing through the midpoint.

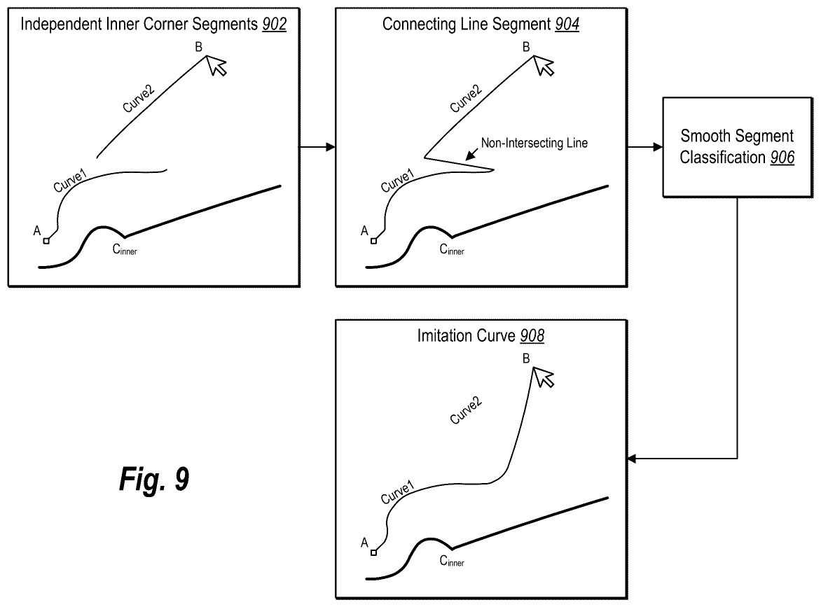

As mentioned above, in some embodiments, the corner-aware imitation system 102 generates an outer-corner fallback curve when the tilt line is too long or tilted far from the primary bisector. Additionally, the corner-aware imitation system 102 also generates an inner-corner fallback curve in certain circumstances. FIG. 9 illustrates a corner-aware imitation system generating an inner-corner fallback curve in accordance with one or more embodiments.

In certain cases, non-intersecting inner imitation segments 902 are joined with a connecting line segment 904 that does not intersect either the first segment or the second segment at points other than the beginning/end points, and an inner-corner fallback is subsequently performed. In such cases, the underlying reference edge corner segment is reclassified as a smooth segment 906. Specifically, the corner segment put back through Algorithm 1 (Offset Lines Computation) to generate new point pair sets. Subsequently, corner-aware imitation system 102 performs curve fitting of the candidate points to generate a new imitation edge segment and, based on the new imitation edge segment, an imitation curve 908.

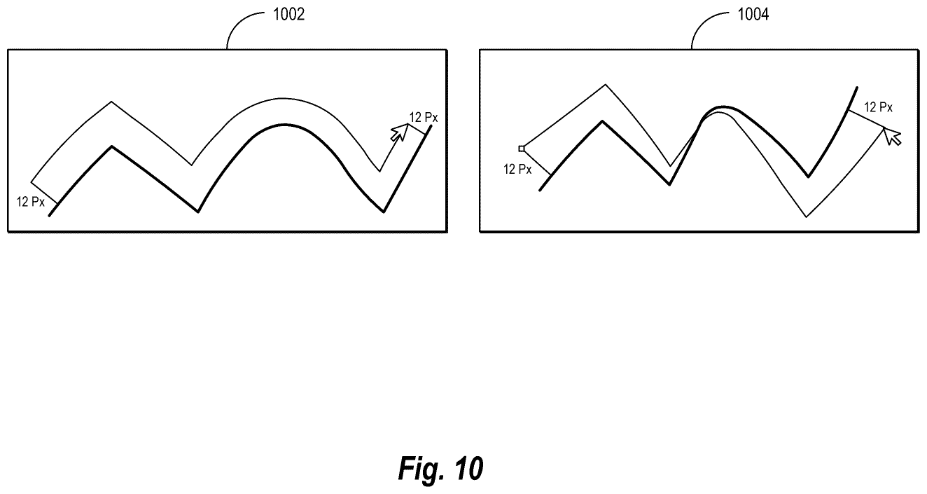

As noted above, in certain embodiments, the corner-aware imitation system 102 generates an imitation edge with one or more corners by tracing the trajectory of a reference curve. In addition, the corner-aware imitation system 102 facilitates the generation of an imitation edge by providing reference snapping guides. FIG. 10 illustrates the corner-aware imitation system providing snapping guides in accordance with one or more embodiments.

As illustrated in FIG. 10, the corner-aware imitation system 102 generates offset feedback. In some embodiments, the corner-aware imitation system 102 displays an offset length from the reference edge to the second input location. In some cases, the offset length is the Euclidean distance from the reference edge to the second input location. In various embodiments, the offset length is displayed in the current document units, affording users the convenience to alter the document units. In some cases, the corner-aware imitation system 102 generates unequal offset feedback indicating an offset from the second input location to the reference edge where a distance from the second input location to the reference edge is different from a distance from the first input location to the reference edge. As mentioned above, the corner-aware imitation system 102 displays the unequal offset distance from the second input location to the reference edge in the digital image.

As further illustrated in FIG. 10, the corner-aware imitation system 102 generates equal offset snapping guides 1002. The offset snapping guides, in some cases, align the second input location with the first input location. Specifically, aligning the second user location with the first user input location comprises moving the second input location to a location such that the second input location is a distance from the reference edge equal to the distance between the first input location and the reference edge. In various embodiments, the corner-aware imitation system 102 automatically snaps the second input location to a location within the digital image to achieve an equal offset when the second input location is within a predetermined threshold. In various cases, when selected, the corner-aware imitation system 102 translates the second input location to an equidistant location. In some cases, the offset snapping guides align the second user location with the first user input location where the second user location is on a side of the reference edge different from the first input location 1004.

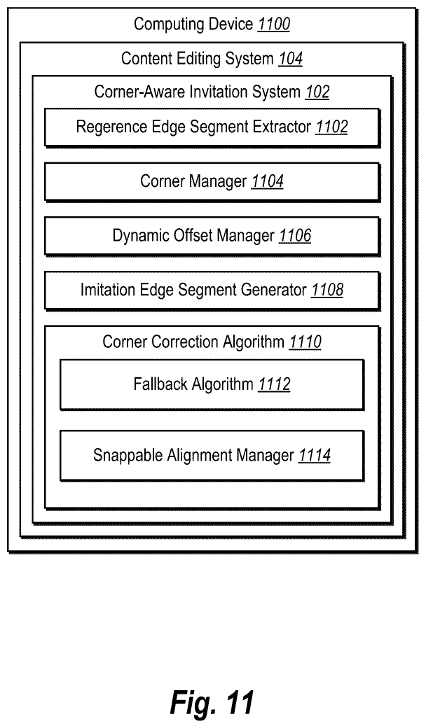

Looking now to FIG. 11, additional detail will be provided regarding components and capabilities of the corner-aware imitation system 102. Specifically, FIG. 11 illustrates an example schematic diagram of the corner-aware imitation system 102 on an example computing device 1100 (e.g., one or more of the client device 110 and/or the server device(s) 106). In some embodiments, the computing device 1100 refers to a distributed computing system where different managers are located on different devices, as described above. As shown in FIG. 11, the corner-aware imitation system 102 includes a reference edge segment extractor 1102, a corner manager 1104, a dynamic offset manager 1106, an imitation edge segment generator 1108, and a corner correction algorithm 1110.

As just mentioned, the corner-aware imitation system 102 includes a reference edge segment extractor 1102. In particular, the reference edge segment extractor 1102 detects a reference edge within a digital image (e.g., a raster image or a vector image) and partitions the reference edge according to anchor points determined within the reference edge. For example, the reference edge segment extractor 1102 utilizes a corner correction algorithm to perform an anchor point analysis on Bezier curves within the reference edge. Additionally, in some cases, the reference edge segment extractor 1102 generates reference edge segments based on the reference edge segmented according to anchor points of Bezier curves. The reference edge segment extractor 1102 thus extracts reference edge segments from a reference edge in a digital image partitioned based on anchor points and their associated Bezier curves within the reference edge.

As shown, the corner-aware imitation system 102 also includes a corner manager 1104. In particular, the corner manager 1104 manages, maintains, detects, determines, or identifies corner segments within a set of reference edge segments. For example, the corner manager 1104 detects or determines corners within a selected reference edge to classify references edge segments as smooth segments or corner segments.

As further illustrated in FIG. 11, the corner-aware imitation system 102 includes a dynamic offset manager 1106. In particular, the dynamic offset manager 1106 manages, maintains, determines, identifies, or generates a set of dynamic offsets (lines) based on one or more input locations and a reference edge. For example, the dynamic offset manager 1106 determines a set of dynamic offsets for an imitation edge utilizing a dynamic offset and a dynamic interval according to a path length along a reference edge.

Additionally, the corner-aware imitation system 102 includes an imitation edge segment generator 1108. In particular, the imitation edge segment generator 1108 manages, maintains, extrapolates, determines, detects, or generates imitation edge segments based on a reference edge. For example, the imitation edge segment generator 1108 generates imitation edge segments from dynamic offset lines that are determined from a set of point pairs. Indeed, the imitation edge segment generator 1108 connects candidate points of a set of point pairs utilizing a curve fitting algorithm. Corresponding to an underlying corner segment, the imitation edge segment generator 1108 performs a generation process to create associated imitation edge segments.

As further illustrated in FIG. 11, the corner-aware imitation system 102 includes a corner correction algorithm 1110. The corner correction algorithm operates in conjunction with, or includes the corner manager 1104, the dynamic offset manager 1106, and/or the imitation edge segment generator 1108. As shown, the corner correction algorithm 1110 includes a fallback algorithm 1112 accessible and usable by other components of the corner-aware imitation system 102. In some cases, the corner correction algorithm 1110 also stores a snappable alignment manager 1114 accessible and usable by other components of the corner-aware imitation system 102. In some cases, the corner correction algorithm 1110 includes an offset lines algorithm and/or a corner to corner edge traversal algorithm, as described above. The corner correction algorithm 1110 communicates with the other components of the corner-aware imitation system 102 to facilitate the operations and functions described herein.

In one or more embodiments, each of the components of the corner-aware imitation system 102 are in communication with one another using any suitable communication technologies. Additionally, the components of the corner-aware imitation system 102 is in communication with one or more other devices including one or more client devices described above. It will be recognized that although the components of the corner-aware imitation system 102 are shown to be separate in FIG. 11, any of the subcomponents may be combined into fewer components, such as into a single component, or divided into more components as may serve a particular implementation. Furthermore, although the components of FIG. 11 are described in connection with the corner-aware imitation system 102, at least some of the components for performing operations in conjunction with the corner-aware imitation system 102 described herein may be implemented on other devices within the environment.

The components of the corner-aware imitation system 102, in one or more implementations, includes software, hardware, or both. For example, the components of the corner-aware imitation system 102 include one or more instructions stored on a computer-readable storage medium and executable by processors of one or more computing devices (e.g., the computing device 1100). When executed by the one or more processors, the computer-executable instructions of the corner-aware imitation system 102 cause the computing device 1100 to perform the methods described herein. Alternatively, the components of the corner-aware imitation system 102 comprises hardware, such as a special purpose processing device to perform a certain function or group of functions. Additionally, or alternatively, the components of the corner-aware imitation system 102 includes a combination of computer-executable instructions and hardware.

Furthermore, the components of the corner-aware imitation system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the corner-aware imitation system 102 may be implemented as part of a stand-alone application on a personal computing device or a mobile device. Alternatively, or additionally, the components of the corner-aware imitation system 102 may be implemented in any application that allows creation and delivery of marketing content to users, including, but not limited to, applications in ADOBE® EXPERIENCE MANAGER and CREATIVE CLOUD®, such as ADOBE® PHOTOSHOP®, ILLUSTRATOR®, and INDESIGN®. “ADOBE,” “ADOBE EXPERIENCE MANAGER,” “CREATIVE CLOUD,” “PHOTOSHOP,” “ILLUSTRATOR,” and “INDESIGN” are either registered trademarks or trademarks of Adobe Inc. in the United States and/or other countries.

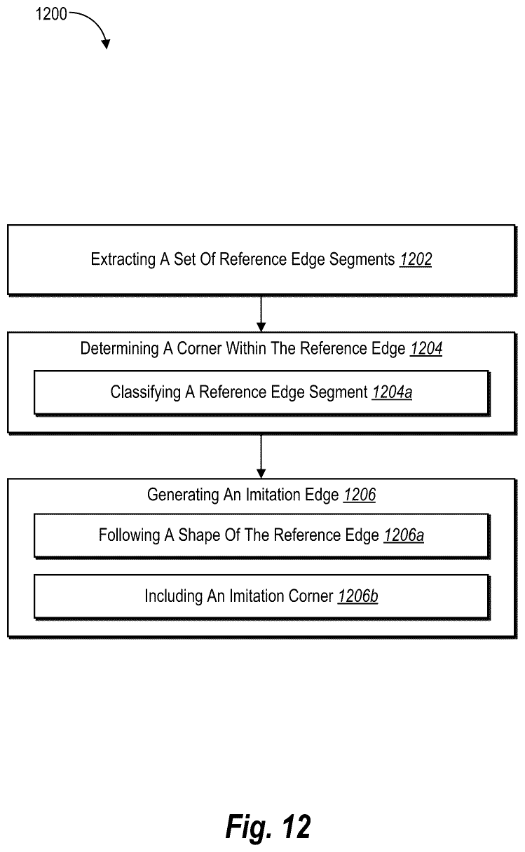

FIGS. 1-11, the corresponding text, and the examples provide a number of different systems, methods, and non-transitory computer readable media for detecting or generating edges in raster images using a pixel window algorithm and/or a segmentation neural network. In addition to the foregoing, embodiments are describable in terms of flowcharts comprising acts for accomplishing a particular result. For example, FIGS. 12-14 illustrate flowcharts of example sequences or series of acts in accordance with one or more embodiments.

While FIGS. 12-14 illustrate acts according to particular embodiments, alternative embodiments may omit, add to, reorder, and/or modify any of the acts shown in FIGS. 12-14. The acts of FIGS. 12-14 are sometimes performed as part of a method. Alternatively, a non-transitory computer readable medium comprises instructions, that when executed by one or more processors, cause a computing device to perform the acts of FIGS. 12-14. In still further embodiments, a system performs the acts of FIGS. 12-14. Additionally, the acts described herein may be repeated or performed in parallel with one another or in parallel with different instances of the same or other similar acts.

FIG. 12 illustrates a flowchart of a series of acts 1200 for generating an imitation edge with corners by tracing the shape of a selected reference edge in accordance with one or more embodiments. In particular, the series of acts 1200 includes an act 1202 of extracting a set of reference edge segments. For example, the act 1202 involves extracting, from a digital image, a set of reference edge segments by segmenting a reference edge depicted in the digital image. In addition, the series of acts 1200 includes an act 1204 of determining a corner within the reference edge. In particular, the act 1204 involves determining a corner within the reference edge by classifying a reference edge segment among the set of reference edge segments as a corner segment. Indeed, in some cases, the act 1204 includes an act 1204a of classifying a reference edge segment among the set of reference edge segments as a corner segment.

As further illustrated in FIG. 12, the series of acts 1200 includes an act 1206 generating an imitation edge. In particular, the act 1206 involves generating, for display, an imitation edge. For example, the act 1206 includes generating, for display, an imitation edge following a shape of the reference edge and including an imitation corner positioned according to the corner within the reference edge. In particular, the act 1206 includes an act 1206a of following a shape of the reference edge. Additionally, the act 1206 involves an act 1206b of including an imitation corner positioned according to the corner within the reference edge.

In one or more embodiments, the series of acts 1200 includes an act of determining the corner within the reference edge by generating a bisector line that bisects two vector paths joined at the corner. In addition, the series of acts 1200 includes an act of determining an angle between the bisector line and a tangent of the two vector paths joined at the corner. Further, the series of acts 1200 includes an act of determining the corner by comparing the angle with a threshold angle.

In some cases, the series of acts 1200 includes an act of detecting a first end of the imitation edge according to a selected position. In addition, the series of acts 1200 includes an act of determining a position for a second end of the imitation edge by using a snapping guide that positions the second end at a second distance from the reference edge based on a first distance from the first end of the imitation edge to the reference edge. Further, the series of acts 1200 includes an act of generating, for the imitation edge, one or more imitation edge segments connecting the first end at the selected position to the second end at the position indicated by the snapping guide.

In certain embodiments, the series of acts 1200 includes an act of detecting a first end of the imitation edge and a second end of the imitation edge. In addition, the series of acts 1200 includes determining a first distance from the first end to the reference edge and a second distance from the second end to the reference edge. Further, the series of acts 1200 includes an act of generating the imitation edge by adding, to the imitation edge, one or more imitation corners corresponding to corners of the reference edge based on the first distance and the second distance.

In various embodiments, the series of acts 1200 includes an act of determining a distance between a first corner segment and a second corner segment from among the set of reference edge segments. Further, the series of acts 1200 includes an act of generating a bisector line of the second corner segment. Additionally, the series of acts 1200 involves an act of determining that the bisector line has a length less than the distance between the first corner segment and the second corner segment. In these or other embodiments, the series of acts 1200 includes an act of adding, to the imitation edge, an imitation corner corresponding to the second corner segment based on determining that the bisector line has a length less than the distance.

In one or more embodiments, the series of acts 1200 includes an act of generating the imitation edge by generating a set of imitation edge segments corresponding to the set of reference edge segments by determining a dynamic offset for a first segment among the set of imitation edge segments based on a position of the first segment. Additionally, the series of acts 1200 includes an act of generating a set of imitation edge segments corresponding to the set of reference edge segments by determining a step interval based on a length of the reference edge and at least one distance between the imitation edge and the reference edge. Further, the series of acts 1200 includes an act of joining the set of imitation edge segments.

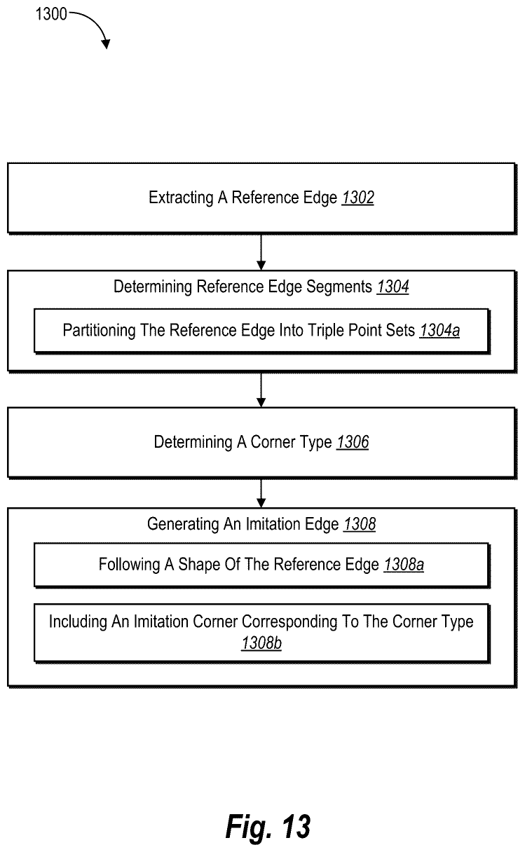

FIG. 13 illustrates a flowchart of a series of acts 1300 for generating an imitation edge with corners by partitioning a reference edge into triple point sets in accordance with one or more embodiments. In particular the series of acts 1300 includes an act 1302 of extracting a reference edge. For example, the act 1302 involves extracting a reference edge depicted in a digital image.

As shown, the series of acts 1300 includes an act 1304 of determining reference edge segments. In particular, the act 1304 involves determining a plurality of reference edge segments by partitioning the reference edge into a plurality of triple point sets. For example, the act 1304 includes an act 1304a of partitioning the reference edge into triple point sets.

As also shown in FIG. 13, the series of acts 1300 includes an act 1306 of determining a corner type. For example, the act 1306 involves determining, from the plurality of reference edge segments, a corner type for a corner depicted in the reference edge.

Additionally, the series of acts 1300 includes an act 1308 of generating an imitation edge. For example, the act 1308 involves generating, based on the corner type of the corner depicted in the reference edge, an imitation edge following a shape of the reference edge and including, at a location corresponding to a corner location of the corner in the reference edge, an imitation corner corresponding to the corner type. In some cases, the act 1308 includes an act 1308a of following a shape of the reference edge. Additionally, the act 1308 includes an act 1308b of including an imitation corner corresponding to the corner type.

In addition, the series of acts 1300 includes an act of determining the corner type for the corner depicted in the reference edge by generating a first bisector line and a second bisector line that bisect two vector paths joined at the corner. In these or other embodiments, the series of acts 1300 includes an act of selecting a primary bisector from among the first bisector line and the second bisector line based on a direction of an input location indicating a start of the imitation edge relative to the reference edge. In addition, the series of acts 1300 includes an act of generating, based on the corner type of the corner depicted in the reference edge, an imitation edge following a shape the reference edge and including, at a location corresponding to a corner location of the corner in the reference edge, an imitation corner corresponding to the corner type.

In one or more embodiments, the series of acts 1300 includes an act of generating the imitation edge by generating a plurality of imitation edge segments corresponding to the plurality of reference edge segments by: determining a dynamic offset for a first segment of the plurality of imitation edge segments based on a position of the first segment. Additionally, the series of acts 1300 includes an act of determining a first distance from a first end of the imitation edge to the reference edge and a second distance from a second end of the imitation edge to the reference edge. Further, the series of acts 1300 includes an act of determining a step interval based on a length of the reference edge, and a difference between the first distance and the second distance. In these or other embodiments, the series of acts 1300 includes an act of joining the plurality of imitation edge segments.

In some embodiments, the series of acts 1300 includes an act of generating the imitation of edge by generating a plurality of imitation edge segments corresponding to the plurality of reference edge segments. In some cases, the series of acts 1300 includes acts of detecting an intersection point where a first imitation edge segment from among the plurality of imitation edge segments intersects a second imitation edge segment from among the plurality of imitation edge segments. Additionally, the series of acts 1300 includes acts of removing a portion of the first imitation edge segment positioned past the intersection point. Further, the series of acts 1300 includes acts of removing a portion of the second imitation edge segment positioned past the intersection point.

In one or more embodiments, the series of acts 1300 includes an act of determining the corner type for the corner depicted in the reference edge by generating a first bisector line and a second bisector line that bisect two vector paths joined at the corner. Additionally, the series of acts 1300 includes an act of selecting a primary bisector line from among the first bisector line and the second bisector line based on a direction of an input location indicating a start of the imitation edge relative to the reference edge. Further, the series of acts 1300 includes an act of determining an angle between the primary bisector line and a tangent of one of the two vector paths joined at the corner.

In some cases, the series of acts 1300 includes an act of generating the imitation edge by generating a plurality of imitation edge segments corresponding to the plurality of reference edge segments by: determining a dynamic offset for a first segment of the plurality of imitation edge segments based on a position of the first segment. In these or other embodiments, the series of acts 1300 includes an act of determining a first distance from a first end of the imitation edge to the reference edge and a second distance from a second end of the imitation edge to the reference edge. Additionally, the series of acts 1300 includes an act of determining a step interval based on a length of the reference edge, and a difference between the first distance and the second distance. Further, the series of acts 1300 includes an act of joining the plurality of imitation edge segments.

In some embodiments, the series of acts 1300 includes generating the imitation edge by generating a plurality of imitation edge segments corresponding to the plurality of reference edge segments. In addition, the series of acts 1300 includes an act of detecting an intersection point where a first imitation edge segment from among the plurality of imitation edge segments intersects a second imitation edge segment from among the plurality of imitation edge segments. In some cases, the series of acts 1300 includes acts of removing a portion of the first imitation edge segment positioned past the intersection point. Further, the series of acts 1300 includes removing a portion of the second imitation edge segment positioned past the intersection point.

In certain embodiments, the series of acts 1300 includes an act of generating the imitation edge by determining, from the plurality of reference edge segments, a first reference edge segment and a second reference edge segment forming the corner depicted in the reference edge. In addition, the series of acts 1300 includes an act of generating a first imitation edge segment corresponding to the first reference edge segment and a second imitation edge segment corresponding to the second reference edge segment. Further, the series of acts 1300 includes an act of joining the first imitation edge segment and the second imitation edge segment based on a midpoint between the first imitation edge segment and the second imitation edge segment.

In one or more embodiments, the series of acts 1300 includes an act of determining the corner type by determining a first triple point set of the plurality of triple point sets, the first triple point set comprising a segment location, a location of an in-tangent, and a location of an out-tangent. In addition, the series of acts 1300 includes an act of generating an angle between the in-tangent and the out-tangent. Further, the series of acts 1300 includes an act of determining the corner type of the corner based on the angle between the in-tangent and the out-tangent.

In some embodiments, the series of acts 1300 includes an act of determining the corner type by determining a first reference edge segment and a second reference edge segment from among the plurality of reference edge segments. In addition, the series of acts 1300 includes acts of determining a first tangent line of the first reference edge segment and a second tangent line of the second reference edge segment. Further, the series of acts 1300 includes acts of determining a primary bisector line from among a first bisector line and a second bisector line that bisect the first tangent line and the second tangent line. In these or other embodiments, the series of acts 1300 includes an act of determining the corner type of the corner within the reference edge based on the primary bisector line. In some cases, the series of acts 1300 includes acts of generating a normal vector from the reference edge. Furthermore, the series of acts 1300 includes an act of selecting the primary bisector line from among the first bisector line and the second bisector line based on the normal vector. Additionally, the series of acts 1300 includes an act of generating an angle based on the primary bisector line and the first tangent line. Further, the series of acts 1300 includes an act of determining the corner type of the corner within the reference edge based on the angle.

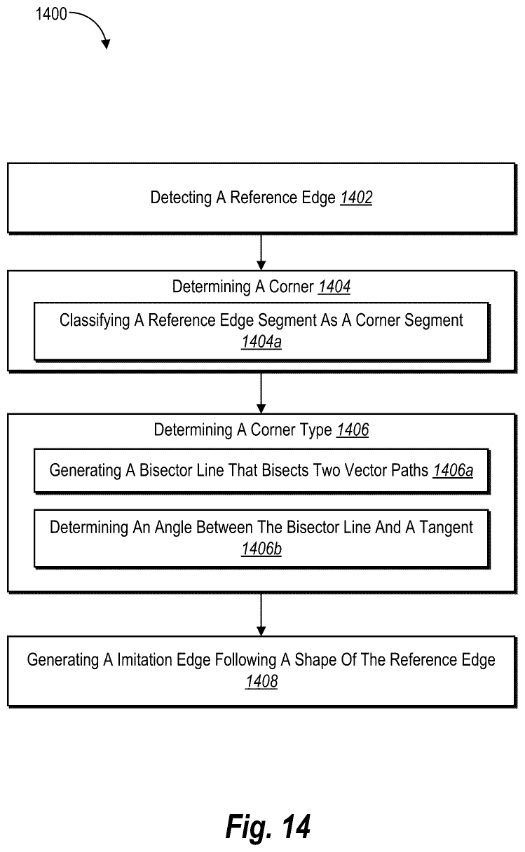

FIG. 14 illustrates a flowchart of a series of acts for generating an imitation edge with corners by determining corner types of an underlying reference edge in accordance with one or more embodiments. In particular, the series of acts 1400 includes an act 1402 of detecting a reference edge. For example, the act 1402 involves detecting, from a digital image, a reference edge comprising a set of reference edge segments.

As shown, the series of acts 1400 includes an act 1404 of determining a corner. In particular, the act 1404 involves determining a corner within the reference edge by classifying a reference edge segment among the set of reference edge segments as a corner segment. In some cases, the act 1404 includes an act 1404a of classifying a reference edge segment as a corner segment.

As further shown in FIG. 14, the series of acts 1400 includes an act 1406 of determining a corner type. In particular, the act 1406 involves determining type within the reference edge by: generating a bisector line that bisects two vector paths joined at the corner and determining an angle between the bisector line and a tangent of one of the two vector paths joined at the corner. In some cases, the act 1406 includes an act 1406a of generating a bisector line that bisects two vector paths. Indeed, in some cases, the act 1406 includes act 1406b of determining an angle between the bisector line and a tangent.

As illustrated, the series of acts 1400 includes an act 1408 of generating an imitation edge following a shape of the reference edge. Specifically, the act 1408 involves generating an imitation edge following a shape of the reference edge and depicting an imitation corner corresponding to the corner type.

In some embodiments, the series of acts 1400 includes an act of generating the imitation edge by determining a fidelity parameter corresponding to a degree of imitation of the reference edge. In addition, the series of acts 1200 includes an act of generating the imitation edge based on the fidelity parameter.

In some cases, the series of acts 1400 includes an act of generating the imitation edge by generating a set of offset lines defining the imitation edge, an offset line of the set of offset lines connecting a point on the reference edge and a corresponding candidate point. Further, the series of acts 1400 includes an act of generating the imitation edge, based on the set of offset lines, by fitting a cubic Bezier spline to the corresponding candidate point, the cubic Bezier spline refined such that the imitation corner is positioned according to the corner within the reference edge. In addition, the series of acts 1400 includes an act of determining a first distance from a first location in the digital image to the reference edge and a second distance from a second location in the digital image to the reference edge. In these or other embodiments, the series of acts 1400 includes an act of determining an offset distance based on the first distance and the second distance. Additionally, the series of acts 1400 includes an act of determining a fidelity parameter based on the offset distance. Further, the series of acts 1400 includes an act of generating the set of offset lines, increasing a quantify of offset lines within the set of offset lines relative to the fidelity parameter.

In one or more embodiments, the series of acts 1400 includes an act of generating the imitation edge by generating a set of imitation edge segments corresponding to the set of reference edge segments, the set of imitation edge segments comprising a first imitation edge segment and a second imitation edge segment that do not intersect. In addition, the series of acts 1400 includes an act of generating a connecting line segment extending from an end of the first imitation edge segment to a beginning of the second imitation edge segment. Further, the series of acts 1400 includes an act of detecting an intersection point where the connecting line segment intersects the first imitation edge segment. In these or other embodiments, the series of acts 1400 includes an act of removing a portion of the first imitation edge segment from the intersection point to the end of the first imitation edge segment. In some cases, the series of acts 1400 includes an act of removing a portion of the connecting line segment from the end of the first imitation edge segment to the intersection point.

Embodiments of the present disclosure may comprise or use a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) use transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 15 illustrates a block diagram of an example computing device 1500 that may be configured to perform one or more of the processes described above. One will appreciate that one or more computing devices, such as the computing device 1500 may represent the computing devices described above (e.g., computing device 1100, server device(s) 106, and/or client device 110). In one or more embodiments, the computing device 1500 may be a mobile device (e.g., a mobile telephone, a smartphone, a PDA, a tablet, a laptop, a camera, a tracker, a watch, a wearable device, etc.). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 includes hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 includes storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
extracting, from a digital image, a set of reference edge segments by segmenting a reference edge depicted in the digital image;
determining a corner within the reference edge by classifying a reference edge segment among the set of reference edge segments as a corner segment; and
generating, for display, an imitation edge following a shape of the reference edge and including an imitation corner positioned according to the corner within the reference edge.

2. The method of claim 1, wherein determining the corner within the reference edge comprises:
generating a bisector line that bisects two vector paths joined at the corner;
determining an angle between the bisector line and a tangent of one of the two vector paths joined at the corner; and
determining the corner by comparing the angle with a threshold angle.

3. The method of claim 1, wherein generating the imitation edge comprises:
detecting a first end of the imitation edge according to a selected position;
determining a position for a second end of the imitation edge by using a snapping guide that positions the second end at a second distance from the reference edge based on a first distance from the first end of the imitation edge to the reference edge; and
generating, for the imitation edge, one or more imitation edge segments connecting the first end at the selected position to the second end at the position indicated by the snapping guide.

4. The method of claim 1, wherein generating the imitation edge comprises:
detecting a first end of the imitation edge and a second end of the imitation edge;
determining a first distance from the first end to the reference edge and a second distance from the second end to the reference edge; and
generating the imitation edge by adding, to the imitation edge, one or more imitation corners corresponding to corners of the reference edge based on the first distance and the second distance.

5. The method of claim 1, wherein generating the imitation edge comprises:
determining a distance between a first corner segment and a second corner segment from among the set of reference edge segments;
generating a bisector line of the second corner segment;
determining that the bisector line has a length less than the distance between the first corner segment and the second corner segment; and
adding, to the imitation edge, an imitation corner corresponding to the second corner segment based on determining that the bisector line has a length less than the distance.

6. The method of claim 1, wherein generating the imitation edge comprises:
determining a first user input at a first location in the digital image and a second user input at a second location in the digital image;
determining a first distance from the first location to the reference edge and a second distance from the second location to the reference edge;
determining a dynamic offset based on a length of the reference edge and a difference between the first distance and the second distance; and
generating the imitation edge based on the dynamic offset.

7. The method of claim 1, wherein generating the imitation edge comprises:
generating a set of imitation edge segments corresponding to the set of reference edge segments by:
determining a dynamic offset for a first segment among the set of imitation edge segments based on a position of the first segment; and
determining a step interval based on a length of the reference edge and at least one distance between the imitation edge and the reference edge; and
joining the set of imitation edge segments.

8. A system comprising:
a memory component; and
one or more processing devices coupled to the memory component, the one or more processing devices to perform operations comprising:
extracting a reference edge depicted in a digital image;
determining a plurality of reference edge segments by partitioning the reference edge into a plurality of triple point sets;
determining, from the plurality of reference edge segments, a corner type for a corner depicted in the reference edge; and
generating, based on the corner type of the corner depicted in the reference edge, an imitation edge following a shape of the reference edge and including, at a location corresponding to a corner location of the corner in the reference edge, an imitation corner corresponding to the corner type.

9. The system of claim 8, wherein determining the corner type for the corner depicted in the reference edge comprises:
generating a first bisector line and a second bisector line that bisect two vector paths joined at the corner;
selecting a primary bisector line from among the first bisector line and the second bisector line based on a direction of an input location indicating a start of the imitation edge relative to the reference edge; and
determining an angle between the primary bisector line and a tangent of one of the two vector paths joined at the corner.

10. The system of claim 8, wherein generating the imitation edge comprises:
generating a plurality of imitation edge segments corresponding to the plurality of reference edge segments by:
determining a dynamic offset for a first segment of the plurality of imitation edge segments based on a position of the first segment;
determining a first distance from a first end of the imitation edge to the reference edge and a second distance from a second end of the imitation edge to the reference edge;
determining a step interval based on a length of the reference edge, and a difference between the first distance and the second distance; and
joining the plurality of imitation edge segments.

11. The system of claim 8, wherein generating the imitation edge comprises:
generating a plurality of imitation edge segments corresponding to the plurality of reference edge segments;
detecting an intersection point where a first imitation edge segment from among the plurality of imitation edge segments intersects a second imitation edge segment from among the plurality of imitation edge segments;
removing a portion of the first imitation edge segment positioned past the intersection point; and
removing a portion of the second imitation edge segment positioned past the intersection point.

12. The system of claim 8, wherein generating the imitation edge comprises:
determining, from the plurality of reference edge segments, a first reference edge segment and a second reference edge segment forming the corner depicted in the reference edge;
generating a first imitation edge segment corresponding to the first reference edge segment and a second imitation edge segment corresponding to the second reference edge segment; and
joining the first imitation edge segment and the second imitation edge segment based on a midpoint between the first imitation edge segment and the second imitation edge segment.

13. The system of claim 8, wherein determining the corner type comprises:
determining a first triple point set of the plurality of triple point sets, the first triple point set comprising a segment location, a location of an in-tangent, and a location of an out-tangent;
generating an angle between the in-tangent and the out-tangent; and
determining the corner type of the corner based on the angle between the in-tangent and the out-tangent.

14. The system of claim 8, wherein determining the corner type comprises:
determining a first reference edge segment and a second reference edge segment from among the plurality of reference edge segments;
determining a first tangent line of the first reference edge segment and a second tangent line of the second reference edge segment;
determining a primary bisector line from among a first bisector line and a second bisector line that bisect the first tangent line and the second tangent line; and
determining the corner type of the corner within the reference edge based on the primary bisector line.

15. The system of claim 14, wherein determining the corner type further comprises:
generating a normal vector from the reference edge;
selecting the primary bisector line from among the first bisector line and the second bisector line based on the normal vector;
generating an angle based on the primary bisector line and the first tangent line; and
determining the corner type of the corner within the reference edge based on the angle.

16. A non-transitory computer-readable medium storing instructions which, when executed by a processing device, cause the processing device to perform operations comprising:
detecting, from a digital image, a reference edge comprising a set of reference edge segments;
determining a corner within the reference edge by classifying a reference edge segment among the set of reference edge segments as a corner segment;
determining a corner type for the corner within the reference edge by:
generating a bisector line that bisects two vector paths joined at the corner; and
determining an angle between the bisector line and a tangent of one of the two vector paths joined at the corner; and
generating an imitation edge following a shape of the reference edge and depicting an imitation corner corresponding to the corner type.

17. The non-transitory computer-readable medium of claim 16, wherein generating the imitation edge comprises:
determining a fidelity parameter corresponding to a degree of imitation of the reference edge; and
generating the imitation edge based on the fidelity parameter.

18. The non-transitory computer-readable medium of claim 16, wherein generating the imitation edge comprises:
generating a set of offset lines defining the imitation edge, an offset line of the set of offset lines connecting a point on the reference edge and a corresponding candidate point; and
generating the imitation edge, based on the set of offset lines, by fitting a cubic Bezier spline to the corresponding candidate point, the cubic Bezier spline refined such that the imitation corner is positioned according to the corner within the reference edge.

19. The non-transitory computer-readable medium of claim 18, wherein generating the imitation edge further comprises:
determining a first distance from a first location in the digital image to the reference edge and a second distance from a second location in the digital image to the reference edge;
determining an offset distance based on the first distance and the second distance;
determining a fidelity parameter based on the offset distance; and
generating the set of offset lines, increasing a quantify of offset lines within the set of offset lines relative to the fidelity parameter.

20. The non-transitory computer-readable medium of claim 16, wherein generating the imitation edge comprises:
generating a set of imitation edge segments corresponding to the set of reference edge segments, the set of imitation edge segments comprising a first imitation edge segment and a second imitation edge segment that do not intersect;
generating a connecting line segment extending from an end of the first imitation edge segment to a beginning of the second imitation edge segment;
detecting an intersection point where the connecting line segment intersects the first imitation edge segment;
removing a portion of the first imitation edge segment from the intersection point to the end of the first imitation edge segment; and
removing a portion of the connecting line segment from the end of the first imitation edge segment to the intersection point.
